(19) United States
(12) Patent Application Publication
(10) Pub. No.: US 2025/0173682 A1
(43) Pub. Date: May 29, 2025

(54) SYSTEM AND METHOD FOR COLLABORATIVE TRAINING AND OPERATING ARTIFICIAL INTELLIGENCE (AI) MODELS IN REAL-WORLD CANDIDATE SCREENING EVENTS

(71) Applicant: Pairwise Technologies LLC, Santa Monica, CA (US)

(72) Inventors: Anton Andreevich Shkel, Aliso Viejo, CA (US); Alireza Tarighat Mehrabani, Los Angeles, CA (US); Sina Moshfeghi, Rancho Palos Verdes, CA (US)

(21) Appl. No.: 18/964,064

(22) Filed: Nov. 29, 2024

Related U.S. Application Data
(60) Provisional application No. 63/603,811, filed on Nov. 29, 2023.

(51) Int. Cl. G06Q 10/1053; G06Q 10/0631

(52) U.S. Cl. CPC G06Q 10/1053; G06Q 10/063112

(57) ABSTRACT

Collaborative training and operating of Artificial Intelligence (AI) models in real-world candidate screening events is provided. A system is provided that includes a processor and a memory that stores a plurality of artificial intelligence (AI) models. The system trains a job requirement estimator (JRE) model based on a first set of external training signals and a first set of feedback training signals received from a candidate skill assessment (CSA) model. The system further trains the CSA model based on a second set of external training signals and a second set of feedback training signals received from each of the JRE model, an electronic candidate screening (ECS) model, and a performance interpretation (PI) model. The system further trains the ECS model and the PI model. The system further applies the plurality of AI models on hiring events related to one or more candidates to generate candidate hiring score information.

### CROSS-REFERENCE TO RELATED APPLICATIONS/INCORPORATION BY REFERENCE

This application claims priority to U.S. Provisional Patent Application No. 63/603,811 filed on Nov. 29, 2023, the entire content of which is hereby incorporated herein by reference.

### FIELD OF TECHNOLOGY

Various embodiments of the disclosure relate to a system and a method for candidate screening. More specifically, various embodiments of the disclosure relate to a system and a method for collaborative training and operating of artificial intelligence (AI) models in real-world candidate screening and hiring events.

### BACKGROUND

The recruitment and hiring process in most organizations is traditionally a labor-intensive and time-consuming task, often plagued by inefficiencies and challenges in accurately matching candidate's skills with job requirements. Conventional methods typically involve manual resume screening, in-person interviews, and subjective decision-making, which are not only resource-intensive but also prone to human error and biases.

With the advent of technology, various automated systems have been developed to aid in the recruitment process. These systems range from simple applicant tracking systems (ATS) to more complex AI-driven platforms that attempt to automate various aspects of the hiring process. Currently, in practice, there are many open technical challenges for the successful and practical use of AI-driven platforms or existing systems in candidate screening and hiring support process. In a first example, most systems operate in silos, focusing on specific aspects of recruitment without effective integration of the overall hiring process. In a second example, many AI-based recruitment tools inherit biases from their training data, leading to unfair candidate assessments. In a third example, existing systems require fixed text formats and document types leading to low coverage. In addition, existing platforms struggle to adapt to the dynamic nature of job requirements and diverse candidate profiles, often resulting in inefficient candidate-job matching. Thus, in practice the recruitment and hiring process is not only resource-intensive but also prone to human error and biases.

Further limitations and disadvantages of conventional and traditional approaches will become apparent to one of skill in the art, through comparison of such systems with some aspects of the present disclosure as set forth in the remainder of the present application with reference to the drawings.

### SUMMARY

A system and a method for collaborative training and operating of artificial intelligence (AI) models in real-world candidate screening and hiring events, are provided substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a diagram of an exemplary network environment including a system for collaborative training and execution of artificial intelligence (AI) models in candidate screening events, in accordance with an embodiment of the disclosure.

FIG. 2 is a block diagram that illustrates the system of FIG. 1 for collaborative training and execution of artificial intelligence (AI) models in candidate screening events, in accordance with an embodiment of the disclosure.

FIG. 3 is a block diagram that illustrates exemplary operations for job requirement estimator (JRE) model, in accordance with an embodiment of the disclosure.

FIG. 4 is a block diagram that illustrates exemplary operations for candidate skill assessment (CSA) model, in accordance with an embodiment of the disclosure.

FIG. 5 is a block diagram that illustrates exemplary operations for ranking candidates based on the JRE model and the CSA model, in accordance with an embodiment of the disclosure.

FIG. 6 is a block diagram that illustrates exemplary operations for electronic candidate screening (ECS) model, in accordance with an embodiment of the disclosure.

FIG. 7 is a block diagram that illustrates exemplary operations for performance interpretation (PI) model, in accordance with an embodiment of the disclosure.

FIG. 8 is a block diagram that illustrates exemplary operations for execution and calibration of the plurality of AI models of the system of FIG. 1, in accordance with an embodiment of the disclosure.

FIG. 9 is a block diagram that illustrates exemplary operations for generation of job description by the system of FIG. 1, in accordance with an embodiment of the disclosure.

FIG. 10 is a block diagram that illustrates exemplary operations to generate candidate benefit information, in accordance with an embodiment of the disclosure.

FIGS. 11A-11D collectively illustrate exemplary user interfaces generated by the disclosed system of FIG. 1, in accordance with an embodiment of the disclosure.

FIG. 12 is a block diagram that illustrates exemplary operations for candidate hiring pipeline controlled by the system of FIG. 1, in accordance with an embodiment of the disclosure.

FIG. 13 is a flowchart that illustrates exemplary operations for collaborative training and execution of artificial intelligence (AI) models in candidate screening events, in accordance with an embodiment of the disclosure.

### DETAILED DESCRIPTION

The following described implementations may be found in a system and a method for collaborative training and execution of artificial intelligence (AI) models in real-world candidate screening and hiring events. Exemplary aspects of the disclosure provide a system that may include at least one processor and a memory coupled to the processor. The memory may store a plurality of artificial intelligence (AI) models, for example, but are not limited to, a job requirement estimator (JRE) model, a candidate skill assessment (CSA) model, an electronic candidate screening (ECS) model, and a performance interpretation (PI) model. Each of such models may be trained (for example in a training phase) based on external training signals/information as well as based on feedback signals/information received from other AI models. For example, the processor may be configured to train the JRE model based on a first set of external training signals and a first set of feedback training signals (i.e. skill profile of hired candidate, feedback) that may be received from the CSA model. The processor may be further configured to train the CSA model based on a second set of external training signals and a second set of feedback training signals (for example skills of job descriptions, on-job and interview performance feedback) that may be received from each of the JRE model, the ECS model, and the PI model. Further, the processor may be further configured to train the ECS model and the PI model based on a third set of external training signals and a fourth set of external training signals, respectively. The processor may be further configured to apply the plurality of AI models (i.e. trained models) on a plurality of hiring events (for example, but not limited to, job descriptions, skill estimation, resume screening, candidate ranking, interview, or feedbacks, offer acceptance) related to one or more candidates. The trained plurality of AI models may provide a first accuracy level. The processor may be further configured to generate candidate hiring information (for example but not limited to, a selection or rejection of candidate, hiring score, skillset gap, etc.) for candidates based on the application of the plurality of AI models on the plurality of hiring events.

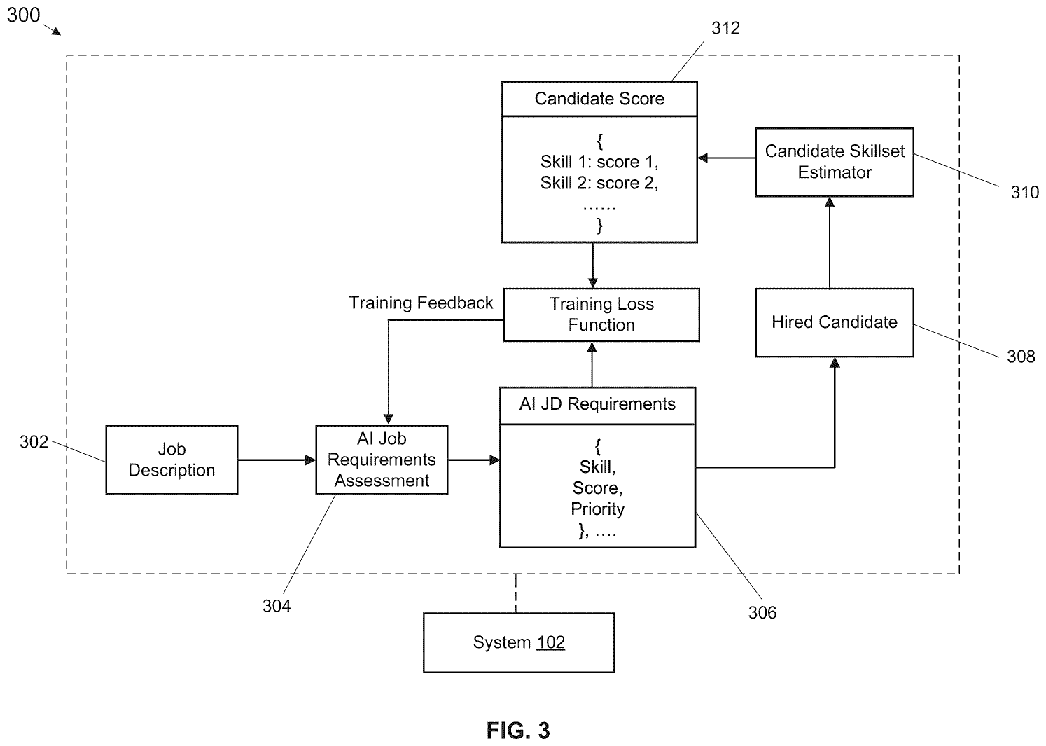

The disclosed system intelligently integrates such multiple AI models for various stages of hiring process, ensures seamless collaboration, data sharing, and enhancing real-time data processing and decision-making capabilities to adapt to dynamic hiring environments, as described for example, in FIGS. 3-8. The system further improves the overall efficiency, accuracy, and fairness in a recruitment process, and further benefits employers and candidates alike.

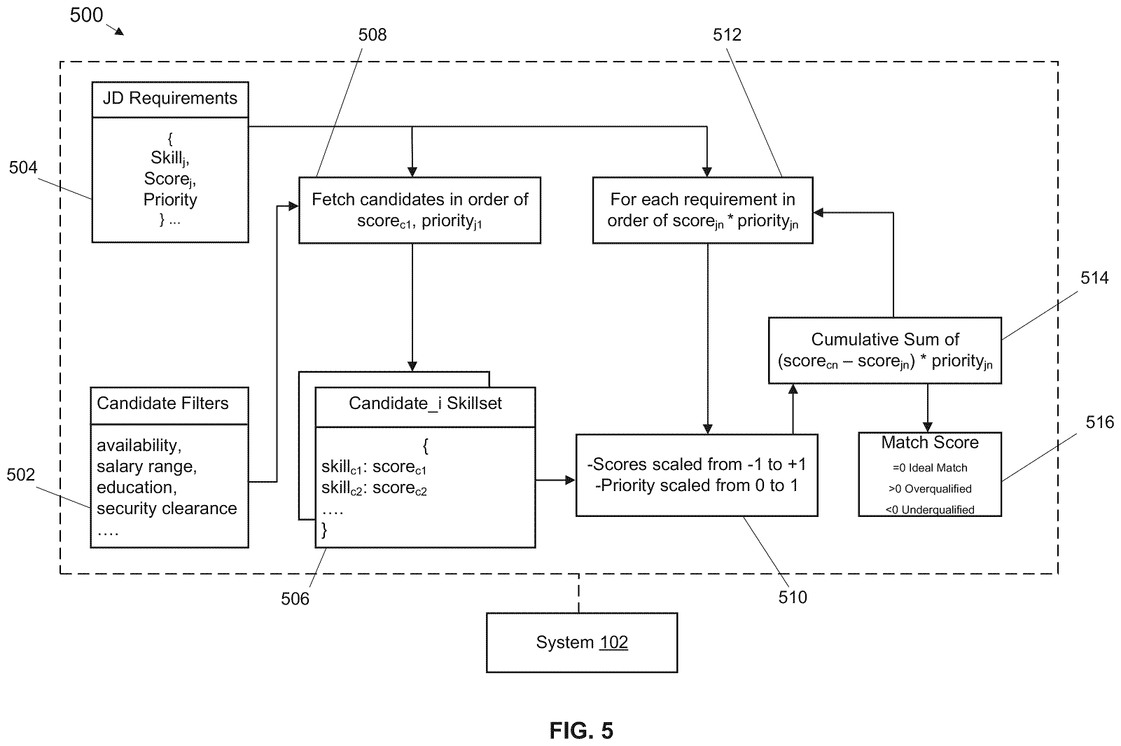

The system 102 may enable the AI model, such as at least one of the plurality of (AI) models), to adapt to hiring events and learn from user behavior. The system may implement a process by which the candidates may be evaluated more accurately, taking into consideration past hiring history (rather than a fixed model which may not consider real-time hiring events, past hiring information, feedback, and the like). The system may further enable conversion of candidate skill assessment from a qualitative form to a quantitative form which may further facilitate intelligent ranking of the candidates, taking in qualitative input, as described, for example, in FIG. 5. Further, the disclosed system 102 may perform a unified embedding approach (as described, for example, in FIG. 5) based on aggregation of metadata related to job description and candidate's resume. Such unified embedding approach may provide several advancements in a recruitment process, for example computational efficiency (based on processing of one combined vector), enhanced contextual understanding, simplified data storage/retrieval, improved candidate-JD matching precision and scalability & flexibility, as described, for example, in FIG. 5. Thus, the system may represent a significant advancement in the field of recruitment and human resource management, offering a comprehensive, efficient, and bias-free approach to modern hiring challenges.

During an operational phase, the disclosed system may iteratively improve an accuracy of the plurality of AI models. At a particular instance, the processor may be configured to execute the plurality of AI models with the first accuracy level. The processor may be configured to apply the plurality of AI models (i.e. trained models) on the plurality of hiring events related to one or more candidates. An output result from the JRE model may be utilized as at least one input parameter for each of the CSA model, the ECS model, and the PI model. The processor may periodically calibrate the CSA model for each hiring event based on the second set of feedback training signals received from each of the JRE model, the ECS model, and the PI model. The calibration of the CSA model may include reconfiguring one or more candidate assessment criterions. The calibration may ensure that the assessment criteria for candidates remain up-to-date and aligned with the current job market trends and organizational needs. Such adaptability may be practically useful in maintaining the relevance and effectiveness of the candidate assessment process.

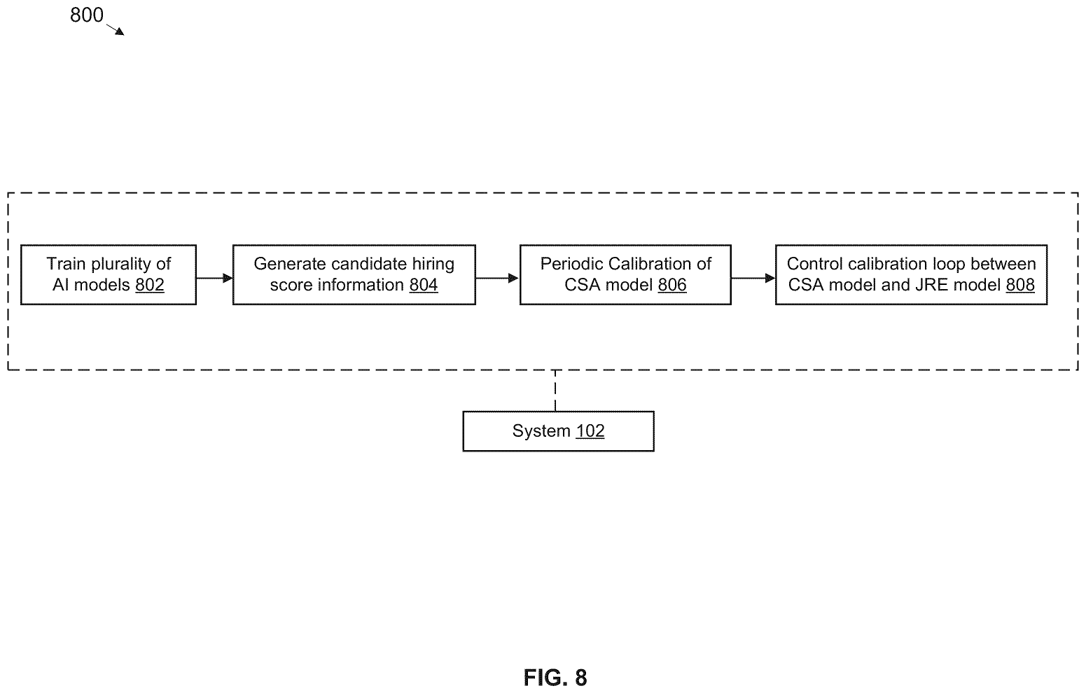

The processor may be further configured to control a calibration loop between the CSA model and the JRE model for each hiring event. Each calibration event of the CSA model may further calibrate the JRE model to further increase an accuracy of the plurality of AI models from the first accuracy level to a second accuracy level. Such continual improvement may be useful in evolving job requirements and candidate profiles, which may further lead to more accurate job-candidate matches over time. The formation of the calibration loop selectively between the CSA model and the JRE model for each hiring event may allow targeted improvements. Such selective calibration ensures that specific aspects of the hiring process, which may require refinement and focused attention, may lead to more nuanced and effective model adjustments. Such approach may not only enhance the overall system efficiency but also tailor the AI models to specific hiring contexts and requirements. Further recalibration of the JRE model 106 may improve the accuracy of the determination of the skill requirement information based on actual job description and real-time candidate assessment, as described, for example, in FIG. 8. Further, based on the receipt of real-time feedbacks from other AI models, the system features a sophisticated feedback loop mechanism where the JRE model, the CSA model, the ECS model, and the PI model are interlinked. Such feedback loop mechanism allows each model to receive and integrate feedback from the others. For instance, the CSA model is trained not only with its own external training signals but also with feedback from the JRE, ECS, and PI models. Such cross-model feedback loops and calibration of models may significantly enhance the precision and relevance of outputs of the AI models as well as for a recruitment pipeline for an organization. Further, the disclosed system may allow the comprehensive training of the AI models and assessment of the candidates based on a large amount of data (i.e., millions of records) retrieved from variety of such data sources. This may further enhance the accuracy and correctness of a candidate's assessment in the field of recruitment and human resource management.

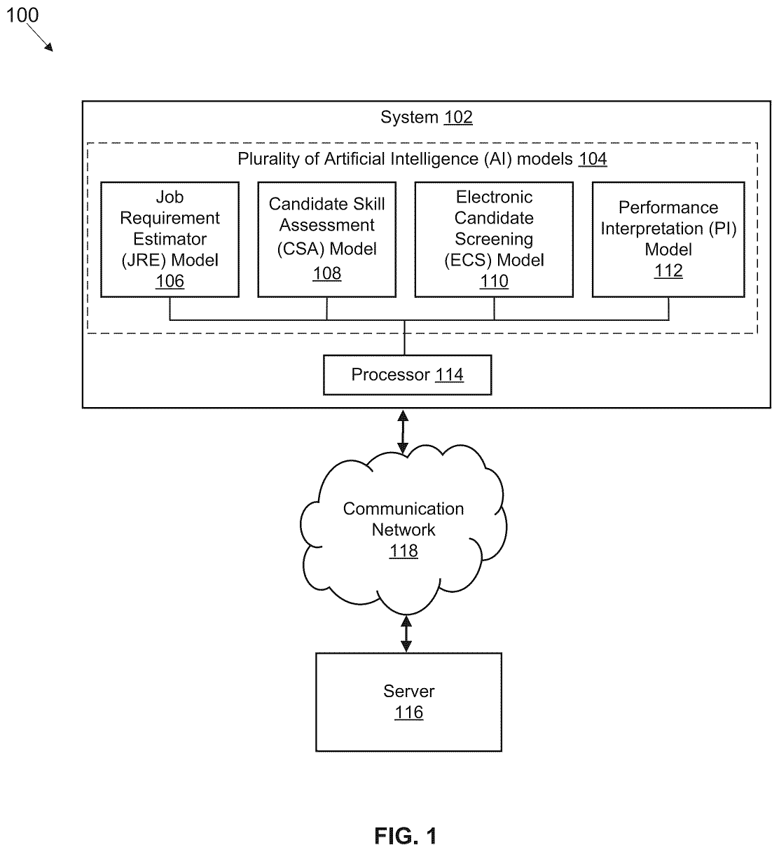

FIG. 1 is a diagram of an exemplary network environment including a system for collaborative training and execution of artificial intelligence (AI) models in candidate screening events, in accordance with an embodiment of the disclosure. With reference to FIG. 1, there is shown a network environment 100. The network environment 100 may include a system 102. The system 102 may include a plurality of artificial intelligence (AI) models 104 and a processor 114. The plurality of AI models 104 may include a job requirement estimator (JRE) model 106, a candidate skill assessment (CSA) model 108, an electronic candidate screening (ECS) model 110, and a performance interpretation (PI) model 112. The network environment 100 may further include a server 116 communicably coupled with the system 102 via a communication network 118. The system 102 and the server 116 are shown as two separate devices; however, in some embodiments, the entire functionality of the server 116 may be included in the system 102, without deviating from scope of the disclosure.

The system 102 may comprise suitable logic, circuitry, interfaces, and/or code that may be configured to train each of the plurality of AI models 104 based on corresponding external signals and feedback signals received from different AI models. The training of different AI models for candidate screening events are described, for example, in FIGS. 3-7. The system 102 may be further configured to generate candidate hiring score information based on the trained plurality of AI models 104. The system 102 may be further configured to calibrate the plurality of AI models 104 for different hiring events to further enhance the accuracy of the plurality of AI models 104 from a first accuracy level to a second accuracy level. The operation and the calibration of the plurality of AI models 104 are described, for example, in FIG. 8. Examples of the system 102 may include, but are not limited to, an automated recruitment or hiring machine, an artificial intelligence (AI) system, a computing device, a smartphone, a cellular phone, a mobile phone, a mainframe machine, a server, a computer work-station, and/or a consumer electronic (CE) device.

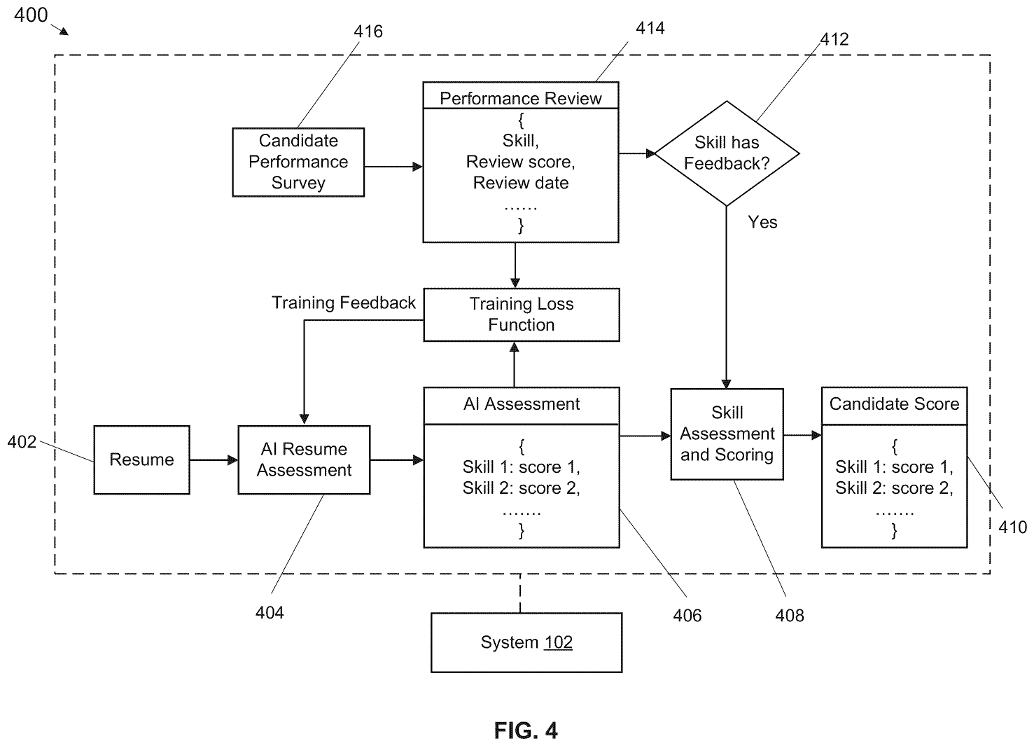

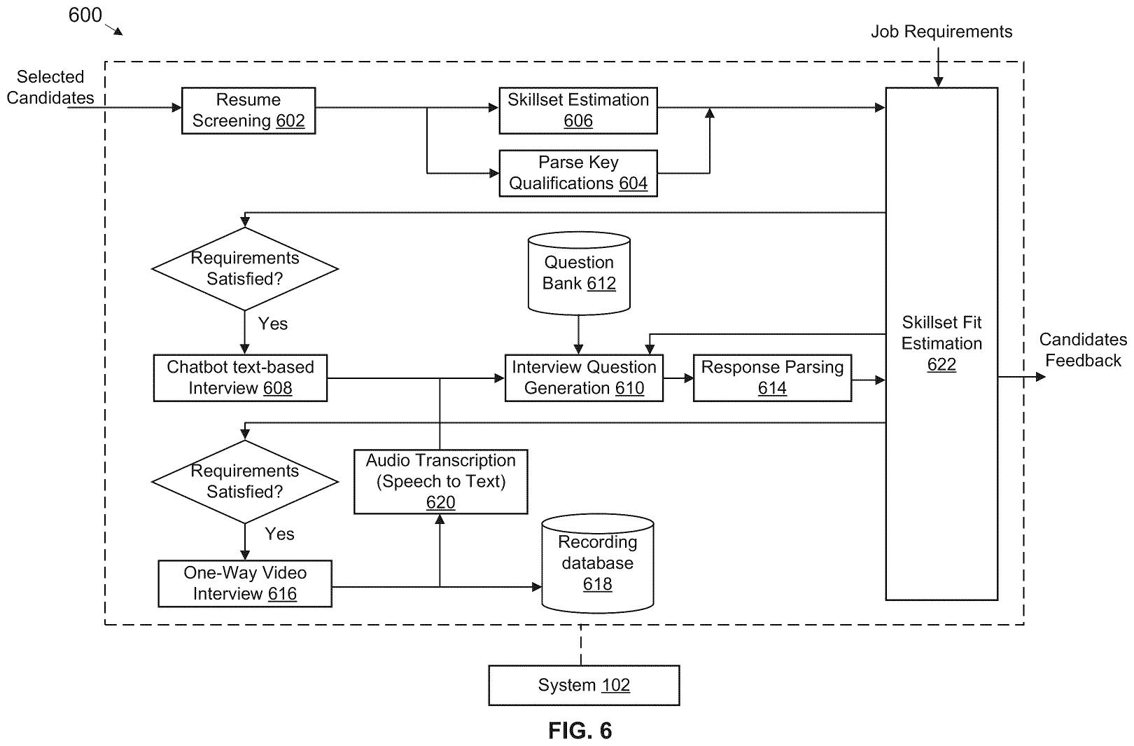

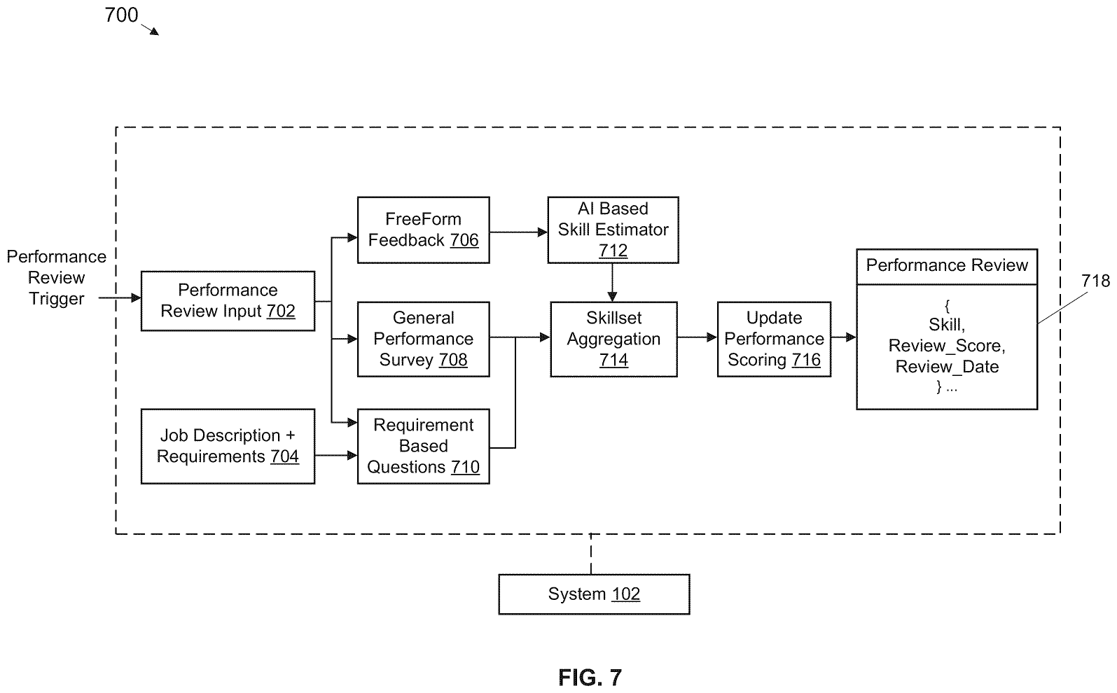

The plurality of AI models 104 may include, but is not limited to, the JRE model 106, the CSA model 108, the ECS model 110, and the PI model 112. The four number of AI models shown in FIG. 1 is presented merely as an example. The plurality of AI models 104 may include only one AI model or more than four AI models for real-world candidate screening and hiring events, without deviating from the scope of the disclosure. The JRE model 106 may receive a set of job descriptions, extract skill requirement information, and determine first score information related to the extracted skill requirement information, where the determination may be based on a set of feedback training signals from the CSA model 108. The functionality of the JRE model 106 is further described, for example, in FIG. 3. The CSA model 108 may receive resume-related information related to one or more candidates and output candidate skill information and second score information related to the candidate skill information. The functionality of the CSA model 108 is further described, for example, in FIG. 4. The ECS model 110 may determine skillset gap information based on outputs of the JRE model 106 and the CSA model 108, and further determine candidate assessment information based on different interview based methods (for example a chatbot text-based interview and/or video-based interview). The functionality of the ECS model 110 is further described, for example, in FIG. 6. The PI model 112 may receive performance feedback information related to the skill requirement information and a set of job descriptions, and generate performance score information. The functionality of the PI model 112 is further described, for example, in FIG. 7. Each of the plurality of AI models 104 may receive different external training signals and feedback training signals from other of the plurality of AI models 104 for different hiring or performance events.

The plurality of AI models 104 may be a classifier, regression, or clustering model which may be trained (or are to be trained) to identify a relationship between inputs, such as features in a training dataset and output labels. The plurality of AI models 104 may be defined by its hyper-parameters, for example, number of weights, cost function, input size, number of layers, and the like. The parameters of the AI model may be tuned and weights may be updated so as to move towards a global minima of a cost function for the AI model. After several epochs of the training on the feature information in the training dataset, the AI model may be trained to output a prediction/classification result for a set of inputs. The prediction result may be indicative of a class label for each input of the set of inputs (e.g., input features extracted from new/unseen instances).

The AI model may include electronic data, which may be implemented as, for example, a software component of an application executable on the system 102. The AI model may rely on libraries, external scripts, or other logic/instructions for execution by a processing device, such as the processor 114. The AI model may include code and routines configured to enable a computing device, such as the processor 114 to perform one or more operations (such as skill estimation, candidate skill assessment, candidate screening, and performance capture, etc.). Additionally or alternatively, the AI model may be implemented using hardware including a processor, a microprocessor (e.g., to perform or control performance of one or more operations), a field-programmable gate array (FPGA), or an application-specific integrated circuit (ASIC). Alternatively, in some embodiments, the AI model may be implemented using a combination of hardware and software.

In an embodiment, the plurality of AI models 104 may be a neural network which may be further a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before, while training, or after training the neural network on a training dataset. Each node of the neural network may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to the same or a different mathematical function. In training of the neural network, one or more parameters of each node of the neural network may be updated based on whether an output of the final layer for a given input (from the training dataset) matches a correct result based on a loss function for the neural network. The above process may be repeated for same or a different input till a minima of loss function may be achieved and a training error may be minimized. Several methods for training are known in art, for example, gradient descent, stochastic gradient descent, batch gradient descent, gradient boost, meta-heuristics, and the like.

Examples of the neural network (or the AI model) may include, but are not limited to, a deep neural network (DNN), a convolutional neural network (CNN), a recurrent neural network (RNN), a CNN-recurrent neural network (CNN-RNN), R-CNN, Fast R-CNN, Faster R-CNN, an artificial neural network (ANN), (You Only Look Once) YOLO network, a Long Short Term Memory (LSTM) network based RNN, CNN+ANN, LSTM+ANN, a gated recurrent unit (GRU)-based RNN, a fully connected neural network, a Connectionist Temporal Classification (CTC) based RNN, a deep Bayesian neural network, a Generative Adversarial Network (GAN), and/or a combination of such networks. In some embodiments, the AI model may include numerical computation techniques using data flow graphs. In certain embodiments, the neural network may be based on a hybrid architecture of multiple Deep Neural Networks (DNNs).

The processor 114 may include suitable logic, circuitry, and/or interfaces that may be configured to execute program instructions associated with different operations to be executed by the system 102. For example, some of the operations may include, but not limited to, training of the JRE model 106, training of the CSA model 108, training of the ECS model 110, training of the PI model 112, and generation of the candidate hiring score information based on the plurality of AI models 104. Some of the operations may include, but not limited to, periodically calibration of the CSA model for each hire event and control of a calibration loop between the JRE model 106 and the CSA model 108. In some embodiments, the processor 114 may include one or more specialized processing units, which may be implemented as a separate processor. In an embodiment, the one or more specialized processing units may be implemented as an integrated processor or a cluster of processors that perform the functions of the one or more specialized processing units, collectively. The processor 114 may be implemented based on a number of processor technologies known in the art. Examples of implementations of the processor 114 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The server 116 may include suitable logic, circuitry, interfaces, and/or code that may be configured to store the plurality of AI models 104 and the candidate hiring score information. The server 116 may be configured to store different external training signals and feedback training signals received from different AI models of the plurality of AI models 104. The server 116 may store a set of job descriptions and skill requirement information related to the JRE model 106. The server 116 may store resume-related information and candidate skill information related to the CSA model 108. The server 116 may further store a set of questions and a set of responses related to the Chatbot based interview and may further store behavior information and candidate assessment information related to the video based interview. In some embodiments, the server 116 may store the performance feedback information related to the PI model 112. The server 116 may further store information about hired candidates, for example, contract information, benefit information and one or more job related recommendations.

The server 116 may be implemented as a cloud server and may execute operations through web applications, cloud applications, HTTP requests, repository operations, file transfer, and the like. Other example implementations of the server 116 may include, but are not limited to, a database server, a file server, a web server, a media server, an application server, a mainframe server, or a cloud computing server. In at least one embodiment, the server 116 may be implemented as a plurality of distributed cloud-based resources by use of several technologies that are well known to those ordinarily skilled in the art. A person with ordinary skill in the art will understand that the scope of the disclosure may not be limited to the implementation of the server 116 and the system 102 as two separate entities. In certain embodiments, the functionalities of the server 116 can be incorporated in its entirety or at least partially in the system 102, without a departure from the scope of the disclosure.

The communication network 118 may include a communication medium through which the system 102 and the server 116 may communicate with each other. The communication network 118 may be one of a wired connection or a wireless connection Examples of the communication network 118 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network 118 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, mobile/cellular communication protocols, and Bluetooth (BT) communication protocols.

In some embodiments, the communication network 118 may correspond to a wireless network that may include a medium through which two or more wireless nodes may communicate with each other. The wireless network may be established in accordance with Institute of Electricals and Electronics Engineers (IEEE) standards for infrastructure mode (Basic Service Set (BSS) configurations), or in some specific cases, in ad hoc mode (Independent Basic Service Set (IBSS) configurations). The wireless network may be a Wireless Sensor Network (WSN), a Mobile Wireless Sensor Network (MWSN), a wireless ad hoc network, a Mobile Ad-hoc Network (MANET), a Wireless Mesh Network (WMN), a Wide Area Network (WAN), a Wireless Local Area Network (WLAN), a cellular network, a Long Term Evolution (LTE) network, an Evolved High Speed Packet Access (HSPA+), a 3G network, a 4G network, a 5G network, and the like. The wireless network may operate in accordance with IEEE standards, such as 802 wireless standards or a modified protocol, which may include, but are not limited to, 802.3, 802.15.1, 802.16 (Wireless local loop), 802.20 (Mobile Broadband Wireless Access (MBWA)), 802.11-1997 (legacy version), 802.15.4, 802.11a, 802.11b, 802.11 g, 802.11e, 802.11i, 802.11f, 802.11c, 802.11h (specific to European regulations) 802.11n, 802.11j (specific to Japanese regulations), 802.11p, 802.11ac, 802.11ad, 802.11ah, 802.11aj, 802.11ax, 802.11ay, 802.11az, 802.11 hr (high data rate), 802.11af (white space spectrum), 802.11-2007, 802.11-2008, 802.11-2012, 802.11-2016.

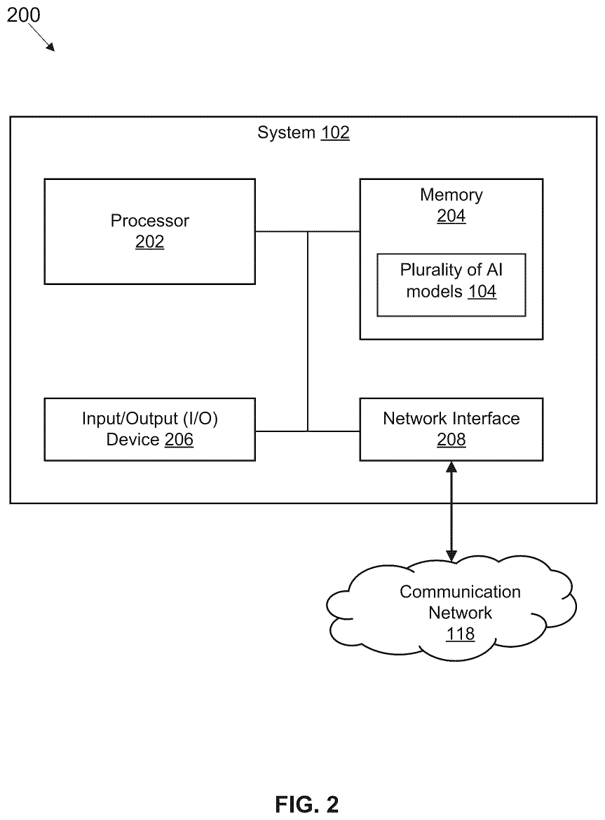

In operation, the disclosed system 102 may be deployed for a recruitment or a hiring process in an organization. The system 102 may include the processor 114 and a memory (shown in FIG. 2) or a database which may store the plurality of artificial intelligence (AI) models 104. The processor 114 may train, calibrate, and execute each of the plurality of AI models 104 based on real-time hiring events to represent a significant advancement in the field of recruitment and human resource management, offering a comprehensive, efficient, and bias-free approach to modern hiring challenges. The system 102 may train the JRE model 106 based on the first set of external training signals and the first set of feedback training signals received from the CSA model as described, for example, in FIG. 3. The system 102 may further train the CSA model 108 based on the second set of external training signals and the second set of feedback training signals received from each of the JRE model 106, the ECS model 110, and the PI model 112 as described, for example, in FIG. 4. The system 102 may further train the ECS model 110 based on the third set of external training signal. The details of the ECS model 110 are provided, for example, in FIG. 6. The system 102 may be further configured to train the PI model 112 based on the fourth set of external training signals. The details of the PI model 112 are provided, for example, in FIG. 7. Based on the trained plurality of AI models 104, the system 102 may further generate the candidate hiring score information for one or more candidates based on an application of the plurality of AI models 104 on a plurality of hiring events. The candidate hiring score information may indicate, but not limited to, a hiring decision, hiring scores, skillset gap, interview feedback, and the like.

In an embodiment, the system 102 may control an interaction among distinct AI models (i.e. plurality of AI models 104), for example, during a training phase and an operational phase of the plurality of AI models 104 for different recruitment or hiring events. Such events may be utilized by the disclosed system 102 for the training, reinforcement, and the calibration of the plurality of AI models 104. The calibration of the different AI models is described, for example, in FIG. 8. Each AI model may be controlled to perform additional interactions with other AI models. For example, job description requirements (obtained as output of the JRE model), may be used to interpret outputs of interviewing and performance feedback. Such interactions among the plurality of AI models 104 are described, for example, in FIGS. 3-8.

FIG. 2 is a block diagram that illustrates the system of FIG. 1 for collaborative training and execution of artificial intelligence (AI) models in candidate screening events, in accordance with an embodiment of the disclosure. FIG. 2 is explained in conjunction with elements from FIG. 1. With reference to FIG. 2, there is shown a block diagram 200 of the system 102 that may be coupled to the server 116 via the communication network 118. The system 102 may further include a processor 202 (such as the processor 114 shown in FIG. 1), a memory 204, an Input/output (I/O) device 206, and a network interface 208. The system 102 may connect to the communication network 118, via the network interface 208. As shown in FIG. 2, the memory 204 may include a plurality of artificial intelligence (AI) models 104. In some embodiments, the plurality of AI models 104 may be stored in the server 116 and communicable coupled to the system 102, via the communication network 118.

The processor 202 may include suitable logic, circuitry, interfaces and/or code that may be configured to execute program instructions associated with different operations to be executed by the system 102. The functions of the processor 202 may be same as the functions of the processor 114 described, for example, in FIG. 1. Therefore, the description of the processor 202 is omitted from the disclosure for the sake of brevity.

The memory 204 may comprise suitable logic, circuitry, interfaces and/or code that may be configured to store the plurality of AI models 104 and the candidate hiring score information. The memory 204 may be further configured to store different external training signals and feedback training signals received from different AI models of the plurality of AI models 104. The memory 204 may store a set of job descriptions and skill requirement information related to the JRE model 106. The memory 204 may further store resume-related information and candidate skill information related to the CSA model 108. The server 116 may further store a set of questions and a set of responses related to the Chatbot-based or video-based interview and may further store behavior information and candidate assessment information related to the video based interview. In some embodiments, the server 116 may store the performance feedback information related to the PI model 112. The server 116 may further store information about hired candidates, for example, contract information, benefit information and one or more job-related recommendations. Examples of the implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may comprise suitable logic, circuitry, interfaces, and/or code that may be configured to act as an I/O channel/interface between a user (not shown) and the system 102. The I/O device 206 may comprise various input and output devices, which may be configured to communicate with different operational components of the system 102. For example, the I/O device 206 may receive information about the first set of external training signals, the second set of external training signals, the third set of external training signals, and the fourth set of external training signals related to each of the plurality of AI models 104. The I/O device 206 may receive information including, but not limited to, a set of job descriptions, a skill requirement, an interview feedback, a performance review, candidate behavior, a hiring decision, a resume, a set of interview questions, an employee contract, job related benefits, job recommendations, and the like. Further, the I/O device 206 may output information about, but is not limited, to, the candidate hiring score information, hiring decisions, interview performance, the set of responses for the interview, priorities related to skill requirements, candidates, questions, contracts, benefits, and the like. Examples of the I/O device 206 may include, but are not limited to, a touch screen, a keyboard, a mouse, a joystick, a microphone, and a display screen. The display screen may be a touch screen which may enable a user to provide a user-input via the display screen. The touch screen may be at least one of a resistive touch screen, a capacitive touch screen, or a thermal touch screen. The display screen may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display screen may refer to a display screen of a head mounted device (HMD), a smart-glass device, a see-through display, a projection-based display, an electro-chromic display, or a transparent display.

The network interface 208 may comprise suitable logic, circuitry, interfaces, and/or code that may be configured to facilitate communication with the server 116, with other on-chip circuits, or with other network devices, via the communication network 118. The network interface 208 may be implemented by use of various known technologies to support wired or wireless communication with the communication network 118. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

The functions or operations executed by the system 102, as described in FIG. 1, may be performed by the processor 202. The operations executed by the processor 114 or the processor 202 are described in detail, for example, in FIGS. 3-13.

FIG. 3 is a block diagram that illustrates exemplary operations for job requirement estimator (JRE) model, in accordance with an embodiment of the disclosure. FIG. 3 is explained in conjunction with elements from FIG. 1 and FIG. 2. With reference to FIG. 3A, there is shown a diagram 300. As shown, the diagram 300 may include a job requirement estimator (JRE) model 106 of a plurality of artificial intelligence (AI) models 104 stored in the memory 204 of the disclosed system 102. The exemplary operations of the block diagram 300 may be performed by any computing system, for example, by the system 102 of FIG. 1, by the processor 114 of FIG. 1, or by the processor 202 of FIG. 2.

The JRE model 106 may be trained to estimate job description requirements based on one or more job postings. The processor 202 may be configured to control the JRE model 106 to receive a set of job descriptions. The set of job descriptions may be related to different job requirements or positions for an organization, an institute, or a person. The processor 202 may receive the set of job descriptions (such as job description 302 shown in FIG. 3) from a user (for example a hiring manager or a recruiter), via the I/O device 206. In some embodiments, the set of job descriptions may be stored in the memory 204 or in the server 116 and may be further retrieved based on a request received from the processor 202. The set of job descriptions may be considered as the first set of external training signals to train the JRE model 106. The set of job descriptions may include, but is not limited to, a plain-text job description, or a programmatically stored object containing keywords, requirements, and other related data. The set of job descriptions may be of arbitrary length and may include content related to the organization or the institute for which a job description may be formed. The set of job descriptions may include different skills required from a candidate. Such skills may be related to an academic qualification, a work experience, work related responsibilities, a designation, a technical domain, a professional/academic certifications, functional areas, demographic or personal information (like age, gender, location, marital status, race, salary, and the like) related to a candidate to be hired.

The processor 202 may be further configured to control the JRE model 106 to extract skill requirement information (or job description requirements) based on the received set of job descriptions. The JRE model 106 may perform an AI job requirement assessment 304 (in FIG. 3) to extract the skill requirement information based on the set of job descriptions. The skill requirement information may indicate a set of requirements related to one or more job postings. The set of requirements in a representation may enable comparison to candidates, performance feedback, and interaction with other interconnected AI models (like other of the plurality of AI models 104). The skill requirement information or the set of requirements may be a plain-text pre-specified skill keywords, or an encoded numerical representation of the skill which may be generated from the trained JRE model 106. Such pre-specified skill keywords, or the encoded numerical representation may enable merging of nearly identical skills indicated in the set of job descriptions received by the JRE model 106. In an embodiment, the AI job requirement assessment 304 of the JRE model 106 may be a pre-trained natural language processing model (a generative or encoder-only transformer architecture) to determine the skill requirement information or the set of requirements based on the received set of job descriptions. In some embodiments, the AI job requirement assessment 304 may include a JD (job description) requirements parser, for example, a natural language parser (NLP) model which may be configured to analyze the input set of job descriptions (like text-based), extract key job requirements (i.e. skill requirement information) from the set of job descriptions, and further assess an importance of each extracted skill requirement. The model may be built around a pre-trained encoder-only transformer architecture, where one component of the model is a keyword extraction model, in which an embedded representation may be processed for both the entire text sequence and individual words/tokens in the text. Further, based on computation of cosine similarity between the text and each individual token, the processor 202 may quantify or determine how important each token is in the context of the text. In an embodiment, the processor 202 may store the extracted keywords in a string representation or the keywords may be stored in an encoded format such the related skills may be grouped.

In an embodiment, the AI job requirement assessment 304 may include a another component that may be a context-specific model in which an encoded output of each keyword along with an encoded value of the full text is passed into a regression model, (i.e. implemented with a single layer fully-connected regression network), and further multiple outputs may be determined corresponding to skill requirements data (i.e. value, skill level, priority, and strictness of each requirement). The processor 202 may be configured to train the JRE model 106 to classify the extracted keywords to skill or qualification requirements. Therefore, an output of the JRE model may be the set of requirements (i.e. skill requirement information), each represented by a keyword with associated data. The JRE model 106 may be further configured to determine first score information (as priority) related to the determined skill requirement information (i.e. set of requirements). The first score information may indicate a priority of a skill requirement to indicate how important is a particular skill requirement for a particular job posting as shown, for example, as AI job description (JD) requirement 306 in FIG. 3. In an embodiment, the processor 202 may train the JRE model 106 based on association between the set of job descriptions (or the extracted keywords) and the skill requirement information (i.e. skill requirements) and the associated skill level (i.e. first score information). In another embodiment, the JRE model 106 may be trained based on manual annotation of the set of job descriptions, where the skill requirement information (i.e. set of requirements) and the first score information (i.e. skill level) may be estimated by trained annotators. The manual annotations may allow the users (like hiring mangers or representatives) to define the importance of different skills as per the job descriptions.

In an embodiment, the processor 202 may train the JRE model 106 based on the first set of feedback training signals received from other of the plurality of AI models 104 (for example the CSA model 108). The first set of feedback training signals may be related to one or more hired candidates (such as hired candidate 308 shown in FIG. 3). In an event, based on a selection and hiring of candidate for a particular skill requirement, the feedback related to the hired candidate may be useful to train the JRE model 106. For example, the skill profile of the hired candidate may be used as the first set of feedback training signals. As shown in FIG. 3, for example, a candidate skill estimator 310 may determine the skill profile of the hired candidate and provide the determined skill profile for the training of the JRE model 106. The skill profile of the hired candidate may act as an exact match with the set of job descriptions input to the JRE model 106 and therefore considered as a positive training signal. The matched skills may be given highest priority or score level (i.e. first score information). Such skill profile of the hired candidate may be received from the CSA model 108. In such case, the CSA model 108 may include the candidate skill estimator 310. Details related to the CSA model 108 are provided, for example, in FIG. 4. Similarly, the skill information of one or more rejected candidates may be used as a training signal for the JRE model 106, for example considered as a negative training signal for the JRE model 106. The JRE model 106 may tune one or more weights towards the skill of the hired candidates and away from skills of the rejected candidates. The CSA model 108 may further provide information about hiring decision, interview feedback about the candidates as the first set of feedback training signals to train the JRE model 106. In some embodiments, the available transcripts of the interview performed may be considered as feedback training signal in addition to other feedback signal provided to the JRE model 106. Based on the hiring decisions or feedback (i.e. related to the skill) of new candidates, the processor 202 may be configured to further re-train or refine the JRE model 106 to enhance accuracy of the JRE model 106 on real-time basis.

In addition to such feedback information about hired/rejected candidates, the JRE model 106 may receive candidate score 312 (shown in FIG. 3) which may indicate the skill requirement information about the hired or rejected candidates and score assigned to such skill requirements. The processor 202 may control the CSA model 108 to provide such candidate score 312 (as the first set of external training signals) to train the JRE model 106. Thus, based on the first set of external training signals (i.e. set of job descriptions) and the first set of feedback training signals, the trained JRE model 106 may indicate associations between the skill requirements for different jobs (i.e. indicated in the set of job descriptions) for different candidates (like hired candidates or rejected candidates). Due to such association, the trained JRE model 106 may output the skill requirement information and the first score information based on an input job description (i.e. one of the set of job descriptions on which the JRE model 106 is trained). As shown in FIG. 3, the JRE model 106 may calculate a training loss function which may indicate an error margin between current model prediction and an actual target or expected outcome. The JRE model 106 may continue the training (or adjust weights) related to the AI job requirement assessment 304 until the error margin is zero or meets a specific minimum threshold criteria such that the prediction of the trained JRE model 106 is accurate.

FIG. 4 is a block diagram that illustrates exemplary operations for candidate skill assessment (CSA) model, in accordance with an embodiment of the disclosure. FIG. 4 is explained in conjunction with elements from FIG. 1, FIG. 2, and FIG. 3. With reference to FIG. 4, there is shown a block diagram 400. As shown, the diagram 400 may include a candidate skill assessment (CSA) model 108 of a plurality of artificial intelligence (AI) models 104 stored in the memory 204 of the disclosed system 102. The exemplary operations of the block diagram 400 may be performed by any computing system, for example, by the system 102 of FIG. 1, by the processor 114 of FIG. 1, or by the processor 202 of FIG. 2.

In an embodiment, the processor 202 may be configured to train the CSA model 108. The CSA model 108 may receive at least resume-related information of a candidate and output candidate skill information based on the received resume-related information. The CSA model 108 may be trained based on a second set of external training signals which may include information about, but is not limited to, candidates resume indicating candidate's skills, interview feedback, performance reviews/surveys about interview/on-job work, or hiring decisions related to one or more candidates. In certain embodiments, the second set of external training signals may be received either as user inputs or from other of the plurality of AI models 104 (like the JRE model 106, the ECS model 110, or the PI model 112), or both. An exemplary process of the CSA model 108 may be to assess candidate's resume and infer their qualifications and skills. Therefore, the CSA model 108 may also be referred to as a resume screening and skill estimator (RSSE). The input to the CSA model 108 may be a free-form candidate resume in a text format. Accordingly, there may be no strict requirement for an organization or formatting of the resume.

The output of the CSA model 108 may indicate candidate's skills and qualifications (i.e. the candidate skill information). The processor 202 may compare such output of the CSA model 108 with the job skill requirements provided by the trained JRE model 106 (as described, for example, in FIG. 3). The output of the CSA model 108 (i.e. candidates skills) may be plain-text pre-specified skill keywords, or an encoded numerical representation of the skill. In an embodiment, the processor 202 may be configured to train the CSA model 108 based on association between resume-related information and candidates skills/qualifications. As shown in FIG. 4, the CSA model 108 may receive one or more resumes (like resume 402) of one or more candidates applied or selected for certain job postings. The received resumes may be analyzed by an AI-based process of the CSA model 108, such as an AI resume assessment 404 (shown in FIG. 4). The processor 202 of the disclosed system 102 may control such process for the analysis of the received resume-related information. Such process may analyze the received resumes of different candidates and provide skills and/or qualification of the candidates as the candidate skill information. The AI resume assessment 404 of the CSA model 108 may input raw text of the resumes and may use a large language model (LLM) based techniques and/or embedding based techniques to extract the candidate skill information from the input resumes of different candidates screened for particular skill requirements (i.e. indicated by the JRE model 106). The CSA model 108 may be implemented based on an encoder-only transformer model, where a first stage may be identification of keywords and a second stage may be an assessment of the keywords through a regression model where associated skills are mapped to values.

The AI resume assessment 404 may provide an AI assessment 406 which may indicate the candidate skill information (i.e. skills extracted from the resumes) as shown in FIG. 4. In an embodiment, the CSA model 108 or the AI assessment 406 may further indicate second score information for each extracted skill. The CSA model 108 or the AI resume assessment 404 may be configured to determine the second score information related to the candidate skill information. The second score information may indicate a priority or importance of the extracted skills in the input resumes. In other words, such scores (or the second score information) may indicate how much a particular skill (i.e. extracted from the resume) is important or may further indicate a skill level of the skills extracted from the resume. In another embodiment, second score information may indicate whether the candidate has a particular skill (indicated in the candidate skill information) or indicate a level or extent of the particular skill present in the candidate. Therefore, the output of the CSA model 108 may be a list of skills, qualifications, and keywords referenced by the resume, with estimations for the level of the skills.

In an alternative embodiment, the CSA model 108 may input additional context around candidate performance (for example related to current or past candidates) and history in the assessment. As shown in FIG. 4, another part of the CSA model 108 includes a process of a skill assessment and scoring 408. The processor 202 may be configured to provide the output of the AI resume assessment 404 (i.e. AI assessment 406 including the extracted skill and related scores) to the process of the skill assessment and scoring 408. The process of the skill assessment and scoring 408 may further augment the output of the AI resume assessment 404 based on real feedbacks received from users (like interviewers, hiring managers, or recruitment team of the candidates). Such feedbacks may be stored in the memory 204 or in the server 116. The processor 202 may automatically retrieve such feedbacks from the memory 204 or the server 116 based on information requests sent either to the memory 204 or the server 116. In an embodiment, the processor 202 may be configured to check (i.e. decision 412) whether the candidate for the particular skill has any feedback stored or not. In case the feedback is stored, the processor 202 may retrieve such feedback for further processing. As shown in FIG. 4, the process of the skill assessment and scoring 408 may receive performance reviews 414. The performance reviews 414 may indicate an interview performance of the candidate for different skills. The performance review 414 for different candidates may be provided as user inputs to the disclosed system or to the CSA model by candidate performance survey 416, which may be conducted with the recruitment team or with hiring manager. In other words, the processor 202 may receive such candidate performance survey 416 (as user inputs) to train the CSA model 108. In an embodiment, the processor 202 may retrieve such candidate performance survey 416 directly from the memory 204 or the server 116 to further train the CSA model 108. In case of a particular skill, the candidate may have a performance review feedback (like the interview feedback) and the processor 202 may combine such feedback with the output (i.e. AI assessment 406) of the AI resume assessment 404. Based on such combination, the processor 202 may control the process of the skill assessment and scoring 408 to determine an actual skill of the candidate and score for such skill of the candidates. Such output skill and related score is referred as candidate score 410 in FIG. 4. The processor 202 may be configured to train the CSA model 108 based on such combined assessment (i.e. skills identified by the AI resume assessment 404 and the performance review 414 of the skills of the candidate). In an embodiment, the candidate score 410 output from the CSA model 108 may be considered as the candidate skill information extracted based on the resume-related information (like resume 402) and the performance review 414 about the interview.

For example, in a case where the performance review 414 (i.e. interview feedback) indicates that the candidate is good in a particular skill, but the AI assessment 406 of the candidates indicates contrasting result (like such skills either not extracted from the resume or with low score), the processor 202 may determine such mismatch as a training signal and train the CSA model 108. In an embodiment, the processor 202 may train the CSA model 108 for the candidate score 410 identified based on the analysis of the skills in the resume 402 and the performance review 414 of the candidates, such that the trained CSA model may output the candidate skill information and the second score information (i.e. as candidate score 410). As shown in FIG. 4, the resume 402, the candidate performance survey 416, the performance review 414 (i.e. interview comments/feedback collected after the interview), and/or hiring decisions for different skills and candidates may be considered as the second set of external training signals to train the CSA model 108. Further, based on the skill requirement extracted by the JRE model 106 and hiring decisions for a particular skill collected from the ECS model 110, the processor 202 may be configured to train the CSA model 108. Such skill requirement and hiring decisions may be considered as the second set of feedback training signals received from the JRE model 106 and the ECS model 110, respectively. In an embodiment, a performance review (i.e. like related to on-job feedback) for a particular skill or candidate may be provided as the second set of feedback training signals to train the CSA model 108. In some embodiments, the processor 202 may retrieve information about employment history of the candidate as another external feedback signal to train the CSA model 108. The processor 202 may be configured to extract or receive such performance review (as feedback) or the employment history from the PI model 112. Such performance review may indicate a performance of a candidate during the on-job work. The details of the PI model 112 is provided, for example, in FIG. 7. The processor 202 may train and calibrate/refine the CSA model 108 on real-time basis through relevant feedback events, such as the past performance reviews, the hire decisions, employment history, and the interview feedback. Therefore, the processor 202 may be configured to train the CSA model 108 based on the received second set of external training signals and the second set of feedback training signals received from other AI models of the disclosed system 102. Therefore, the well-trained CSA model 108 may closely collaborate with other AI models to handle candidate skills assessment accurately.

In the case of the performance reviews and/or the interview feedback, the candidate skill information from the CSA model 108 may be used as a training ground truth. For example, in case, based on the resume screening, the CSA model 108 does not suggest a particular skill in the candidate's resume, however the interview feedback or past feedback suggests such skill as positive result, such mismatch (as the ground truth) may be trained in the CSA model 108 or may be used to re-calibrate the CSA model 108. In an embodiment, the processor 202 may train the CSA model 108 to determine the candidate skill information based on relative classification (i.e. (i.e., skills are determined to be better or worse than expected)). In such case, the ground truth of the skill scores (i.e. first score information of the JRE model 106 or the second score information of the CSA model 108) may be estimated using the job description skill requirements as a point of reference. For example, the processor 202 may adjust, for example, increment or decrement, the skill requirement scores (i.e. first score information of the JRE model 106) by one for a positive or negative skill feedback, respectively. For example, based on the JRE model 106, the skill requirement score (like for C++ programming language) is seven out of ten, however, hiring manger feedback (i.e. interview feedback) for the same skill for a candidate is poor. In such case, the processor 202 may reduce the skill requirement score of the JRE model 106 by one based on the interview feedback received from the CSA model 108. Therefore, the processor 202 may be configured to re-calibrate the JRE model 106 based on information (i.e. external feedback signals) received from the CSA model 108. Further, such coordination between two AI models (for example between the JRE model 106 and the CSA model 108) may avoid any bias being created based on any human feedback. For example, for a particular skill, one model or a person may be positive or another may be negative. However, the coordination between multiple models may help to avoid any bias and may facilitate fair and accurate hiring assessments. Further, as described, for example, in FIG. 3, the skills of the hired candidates may be used as the ground truth of the training for the JRE model 106. In an embodiment, the processor 202 may determine union set of skills (or common skills) in the hired candidate and in the resume screening (i.e. AI resume assessment 404), and train the JRE model 106 and the CSA model 108 for such shared skills.

FIG. 5 is a block diagram that illustrates exemplary operations for ranking candidates based on the JRE model and the CSA model, in accordance with an embodiment of the disclosure. FIG. 5 is explained in conjunction with elements from FIG. 1, FIG. 2, FIG. 3, and FIG. 4. With reference to FIG. 5, there is shown a block diagram 500. The exemplary operations of the block diagram 500 may be performed by any computing system, for example, by the system 102 of FIG. 1, by the processor 114 of FIG. 1, or by the processor 202 of FIG. 2. With reference to FIG. 5, there is shown a scoring process to rank the candidates. The processor 202 may rank the candidates based on a combination of the outputs of the JRE model 106 and the CSA model 108. As shown in FIG. 5, the processor 202 may receive the skill requirement information and the first score information (as described, for example, in FIG. 3) from the JRE model 106. As shown in FIG. 5, JD requirement 504 may indicate skill requirement information and the first score information of the JRE model 106. Further, the processor 202 may be configured to receive the candidate skill information and the second score information (i.e. related to the candidate skill information) from the CSA model 108, as described, for example, in FIG. 4. In an embodiment, the processor 202 may be configured to store outputs of the JRE model 106 and the CSA model 108 in the memory 204 or in the server 116 in a searchable manner to optimize processing speed.

As shown in FIG. 5, candidate skillset 506 may indicate skillset information and related score for one or more candidates. In an embodiment, the processor 202 may be configured to filter the candidates based on different criterion such as, but are not limited to, availability, salary range, education background, or security clearance (as shown in candidates filter 502 in FIG. 5). The processor 202 may be configured to filter or fetch profiles or resumes of different candidates based on selected filtering criterion. Such filtering criterion may be predefined or may be received as user inputs (for example from the hiring manager) or may be automatically defined based on job descriptions or skill requirements defined by the JRE model 106. For example, based on the selection of salary range, information (or scores) of the candidates within a predefined salary range may be retrieved. As shown in FIG. 5, information about the candidates may be fetched (i.e. process 508) based on scores or priorities (i.e. second score information) defined by the CSA model 108. The processor 202 may be configured to fetch candidates (with different scores) for different skill requirements indicated by the JRE model 106. For example, for different skill requirement scores (i.e. first score information), the candidate skill information or related scores (i.e. second score information) may be fetched from the CSA model 108. In an embodiment, the processor 202 may perform different techniques such as hashing and clustering to speed up information filtering performance of the disclosed system 102.

In an embodiment, as shown in 510 process of FIG. 5, scores related to skill requirements and candidate skills may be represented or scaled in a normalized way, for example, with scores ranging from “−1” to “+1”, where “0” may represent an ideal match between the scores related to the skill requirements and the candidate skills. In an embodiment, the processor 202 may be configured to normalize the first score information (related to the skill requirement) and the second score information (related to the candidate skill) into the predefined score ranges. In another embodiment, the scores may be normalized on a scale from “0” to “1”, where “1” may represent an ideal and overqualified match between the scores related to the skill requirements and the candidate skills. Such normalization may convert qualitative information on candidate's skill and skill requirement into quantitative scores. The scores may be scaled for each skill requirement in order of corresponding score and priority, as per 512 shown in FIG. 5. In embodiment, the scores may be obtained based on different metrics, for example, based on an embedding distance, percentages scores, and like. The processor 202 may normalize the scores based on a trained set of metrics. The normalization may be a min-max normalization or may be based on a standard deviation or other similar methods. The processor 202 may be further configured to transform the scores to accurately distribute through the range (“−1” to “+1” or “0” to “1”). The transformation may be based on applying a transformation function (i.e. an exponential or logarithmic transformation). The normalization and transformation may allow a conversion of the qualitative feedback/information on candidate's skills into quantitative scores between pre-defined ranges. Further, such normalized scoring with adjustable ranges and transformations may standardize candidate scores across different models, such as the JRE model 106 and the CSA model 108, using a normalized range like “−1 to 1” or “0 to 1”. In an embodiment, the processor 202 may map categorical scores (e.g., “A”, “B”, “C” grades) to normalized values for consistent comparisons. Various transformation functions (such as a logarithmic function or an exponential function) may be further applied to align scores with human grading patterns. Such transformation functions ensure accurate distributions of scores (related to the candidates and job description) within the selected range.

As shown in FIG. 5 (i.e. process 514), the processor 202 may be further configured to compare the first score information (i.e. retrieved from the JRE model 106 about the skill requirements) and the second score information (i.e. retrieved from the CSA model 108 about the candidate skills). In other words, scores from the JRE model 106 and the CSA model 108 or the quantitative scores between pre-defined ranges may be compared to get a final score for intelligent ranking of the candidates. In an embodiment, the processor 202 may be configured to determine a cumulative sum of comparisons of skill requirement scores and candidate's skill scores received from the JRE model 106 and CSA model 108 for different candidates, as shown in FIG. 5. Such cumulative sum may be referred as weighted cumulative sum of scores, where skills may be predefined in the JRE model 106 and/or the CSA model 108 and stored in plain text. In an embodiment, where skills are encoded using a pre-trained transformer model, the distance (e.g., cosine distance) between the required skills and candidate skills may serve as an alternative or additional scoring dimension.

The processor 202 may be further configured to determine a match (i.e. such as match score 516) between the scores (and/or between the skill requirement and candidates skills) to further rank the candidates. For example, in case of an exact match between the first score information (i.e. skill requirement score) and the second score information (i.e. candidate skill score) or between the corresponding skills, the candidate may be ranked higher. Similarly, as shown in FIG. 5, in case a comparison result is higher than zero, a candidate may be determined as overqualified. In such case, the candidate may exceed majority of skill requirements and may have a positive cumulative summation score. Similarly, in case the comparison result is lower than zero, a candidate may be determined as underqualified and may not meet the majority of skill requirements. Such candidates may be eliminated from consideration in the recruitment based on difference in their skill set in comparison with the highest priority required skills. Such rejection performed automatically based on the combination of AI models may fasten the hiring speed. In an embodiment, the processor 202 may calculate embedding distance between scores or vectors (related to candidate and job requirements scores) to further measure skill closeness quantitatively and improve accuracy of the ranking of the candidates. Therefore, based on outputs retrieved from both the JRE model 106 and the CSA model 108 and the normalized and transformed quantitative scores, the processor 202 may determine potential candidates for a particular job requirement. Such combined assessment performed by different AI models may provide accurate selection or rejection of candidates for further stages of a recruitment process.

It may be noted that the JRE model 106 and the CSA model 108 in FIG. 5, are presented merely as an example. The disclosed system 102 may combine or aggregate the outputs of different AI models for accurate assessment during different stages of the recruitment process, without deviating from the scope of the disclosure. Further, comparison of scores of required skills and candidates skills described in FIG. 5, is also presented merely as an example. Similarly, the complete content of the job description, candidate's resume, performance reviews, and other relevant documents may be encoded and compared as a type of match score, without deviating from the scope of the disclosure. These encoded values may be clustered (for example using k-means clustering) to further optimize the match/search performance of the disclosed system 102. In an embodiment, scoring process may be implemented with a single database to cache skill-score pairs or may be a collection of specialized databases to optimize searching and matching process in the disclosed system 102. In an embodiment, the operations described in FIG. 5 may be a part of the ECS model 110 or may be an input to the ECS model 110. The details related to the electronic candidate screening (ECS) model 110 are provided, for example, in FIG. 6.

In accordance with an embodiment, the processor 202 may be configured to generate an aggregated candidate or job embedding for skill assessment. Rather than dealing with multiple sources of information, the disclosed system 102 may aggregate all sources of information for a job description (JD) (or for a candidate) into a single efficient numerical representation. Therefore, the disclosed system 102 may perform a process for embedding JD aggregation where the processor 202 may be configured to receive a first plurality of data components associated with a job description. The first plurality of data components may be received in addition to the job description itself. Further, the first plurality of data components may include, but is not limited to, text-based job description content, location metadata including geographic location, work style, and remote/non-remote options, client-related metadata including client name, industry type, historical job titles, typical salary ranges, and other open positions within the organization, candidate interview feedback specific to a current job and past positions within the client organization, team input and notes from hiring personnel, interview transcriptions for current and relevant previous candidates, and the like.

The processor 202 may be further configured to generate a job description embedding based on an aggregation of the first plurality of data components (i.e. all metadata components) into a single unified embedding that may represent the job requirements, organizational context, and hiring expectations. The job description embedding may indicate a vector-based representation of the job description. In an embodiment, the aggregation may be performed based on different methods, for example, an input concatenation method, an embedding concatenation method, a neural network fusion method. In the input concatenation method, the processor 202 may concatenate the text and data related to the job description into one input sequence, which may be embedded as a single document. In the embedding concatenation method, embeddings from each individual data source may be concatenated to form a larger embedding vector. This vector may be reduced using a technique like principal component analysis (PCA) to reduce memory requirements. In the neural network fusion method, embeddings from each source may be combined via a neural network to generate a final embedding incorporating details from all inputs.

In an embodiment, the processor 202 may be further configured to generate a candidate embedding. For such generation, the processor 202 may receive a second plurality of data components associated with a candidate and resume. The second plurality of data components may include, but is not limited to, text-based resume content, candidate publication records, public web content, code repositories, past and present interview performance feedback associated with relevant job contexts, salary history, work history, and prior performance. The processor 202 may be further configured to generate the candidate embedding based on an aggregation of the second plurality of data components (i.e. all candidate metadata components) into a single unified embedding that captures both technical qualifications and historical performance data of the candidate.

In an embodiment, the processor 202 may be further configured to calculate a fitment score between the job description embedding and the candidate embedding. For the calculation of the fitment score, the processor 202 may determine the similarity between the aggregated embeddings. The fitment score may indicate a match quality between the job description and the candidate skillset or a compatibility between a candidate profile and job requirements based on the aggregated embedding data. In an embodiment, the processor 202 may be extracted from both embeddings through one or a combination of a) comparison to a pre-generated list of skills of interest, specifically through vector similarity metrics, b) clustering analysis, using algorithms like K-means, or density-based spatial clustering of applications with noise (DBSCAN) to group skill categories, and c) classification algorithms, based on neural networks or other trained models. In an embodiment, the processor 202 may calculate the fitment score (i.e. skill fitment) using a combination of cosine similarity scores, Euclidean distance, vector dot product, or similar.

Such unified embedding approach followed by the disclosed system 102 may provide significant improvement in the field of hiring and recruitment. For example, the aggregation of all the metadata into a single embedding may allow the disclosed system 102 to process only one combined vector per candidate or job description, which further avoids the computational redundancy of evaluating each metadata component separately. Thus, the disclosed system 102 may be more computational efficient based on the unified embedding approach. Further, the disclosed system 102, using the unified embedding approach, reduces a number of pairwise comparisons required for skill assessment, streamline candidate-job fitment scoring and further decreases both processing time and computational resources. Further, based on the embedding of the multiple metadata components together (i.e. the first plurality of data components and the second plurality of data components), the disclosed system 102 may capture a richer, context-aware profile that includes information about the candidate's past performance, job-specific requirements, and organizational context. Therefore, the unified embedding may reflect a broader context surrounding both candidate and job description, reduce the risk of disjointed analysis, provide a more holistic view of fitment, and improve overall match quality. This may overall enhance contextual understanding for the candidates and the job descriptions. Further, storage of aggregated embeddings instead of maintaining separate embeddings for each metadata component may simplify storage requirements and enable faster retrieval for large-scale matching.

Further, consolidation of data into one unified embedding may minimize storage overhead, as well as lookup times which may further improve database efficiency and memory usage, especially for high-volume candidate pools or multi-stage recruitment processes. When evaluating multiple interrelated aspects within a single embedding, the disclosed system 102 can more accurately measure subtle relationships and relevancies between candidates and job roles that may otherwise be overlooked. Further, based on the incorporation of factors like interview feedback, industry context, and work style preferences directly into the embedding, the disclosed system 102 may achieve a nuanced alignment that reduces mismatches and better reflects the real-world expectations of hiring managers. In terms of scalability and flexibility in multi-attribute analysis, the single embedding approach scales effectively across multiple roles and candidates without the need for extensive customization. Each unified embedding may naturally adapt to new metadata and may enable flexibility in handling additional data points. Such adaptability may allow for modular expansion without altering core matching algorithm. This makes the process for the disclosed system 102 efficient to scale while maintaining precision in fitment analysis as new metadata categories are introduced.

In an embodiment, the disclosed system 102 may assess skill fitment between a candidate's resume and a job description (JD). For such assessment, the processor 202 may be configured to generate a first embedding representing the JD and related data (i.e. the first plurality of data components) and generate a second embedding representing the candidate's resume. The first embedding and the second embedding may indicate a vector-based representation of the job description and the candidate's resume. The processor 202 may be further configured to generate a third embedding that may represent a skill keyword and one or more associated subskills. The processor 202 may be further configured to project the first embedding (JD) onto the third embedding (skill keyword) and project the second embedding (resume) onto the third embedding (skill keyword). For the projection, the processor 202 may be configured to perform a mathematical operation where a vector is mapped onto another vector. The processor 202 may be configured to perform the projection of two vectors (i.e. a first vector and a second vector), represented by the first embedding and the second embedding, onto a third vector, i.e. represented by the third embedding. The processor 202 may capture a part of each of the first vector and the second vector that may point in the same direction as the third vector (i.e. target vector), which may create a simplified representation focused on a particular aspect, such as the alignment of skills. This may allow a direct comparison between the projected vectors to assess similarity or relevance. One approach for calculation of the projection of a vector onto another vector is to determine a scalar projection. In such approach, the processor 202 may calculate a dot product of the vectors being projected and the vector onto which it is being projected. This dot product may give a measure of alignment between the two vectors. The processor 202 may further divide a resulting value of the dot product by the magnitude of the target vector and further multiply a result by a unit direction of the target vector to provide a final projected vector. Another approach may include decomposition of an original vector into two components: one that is parallel to the target vector and one that is orthogonal, and consideration of the parallel component as the projection.

The processor 202 may be further configured to calculate a distance metric between the projected first embedding (i.e. JD embedding) and the projected second embedding (i.e. resume embedding) within the skill-aligned space. The distance metric may represent a measure of skill fitment between the JD and the resume for the specified skill keyword. Therefore, the disclosed system 102 may be able to measure the skill fitment (or match) between the job description and candidate's resume for one or more specific skill keywords. The distance may represent Euclidean distance between the vectors in a projection space.

The projection of the first embedding (JD) and the second embedding (resume) onto a skill-specific vector rather than comparison in high-dimensional space may reduce the dimensional complexity of the similarity calculation. Further, instead of calculation of distances in a large embedding space (often hundreds or thousands of dimensions), the disclosed system 102 may limit comparisons to a one-dimensional or low-dimensional space aligned with the skill vector. Such lower dimensional comparisons are computationally lighter, reducing memory and processing power requirements. This streamlined projection may further reduce the computational load per candidate, enabling faster processing across larger candidate pools without significant accuracy loss. Further, the disclosed system 102 may perform targeted comparisons focused on specific skill embeddings, which eliminates the need for exhaustive matching across all potential JD and resume pairings. Instead of comparing all elements of JD and resume embeddings, the disclosed system 102 may isolate only those dimensions directly relevant to each skill. By concentrating only on relevant skills, the disclosed system 102 may avoid redundant calculations, particularly when dealing with skill-intensive job descriptions or large candidate databases. This may result in a faster, more focused computation that optimally uses memory and reduces unnecessary processing cycles. Further, based on focus on skill projections for JD, resume, and skill embeddings, the disclosed system 102 may create more compact, skill-specific embeddings. This may eliminate the need to store full-dimensional vectors when only projections on certain skills are necessary. Storage for only skill-projected data may reduce the storage requirements for each candidate-JD pair, which may be especially beneficial when handling large datasets. Embedding storage can be optimized, allowing for more efficient data retrieval and better utilization of database storage capacities. This projection-based approach may allow for modular scaling since each skill-specific projection can be calculated independently. The disclosed system 102 can parallelize the skill projection calculations for multiple skills or candidates, improving performance under load. Such modularity may support scalability across distributed computing environments, where different skill-based projections may be computed concurrently across processing nodes. This may lead to faster, distributed processing and may optimize the system's capacity to handle large volumes of candidate and job data simultaneously. Further, based on the focus on calculations on the skill embedding, the disclosed system 102 may reduce an impact of irrelevant or noisy dimensions in JD or resume embeddings. Thus, the projection may isolate only information pertinent to each skill, to further improve the precision of the skill fitment and related scores. This accuracy in match scoring may reduce error rates and the need for reprocessing or reranking, which can be costly in computational terms. An accurate, low-noise skill fitment metric may lead to better initial matches and may minimize processing overhead related to candidate reranking or further evaluation.

FIG. 6 is a block diagram that illustrates exemplary operations for electronic candidate screening (ECS) model, in accordance with an embodiment of the disclosure. FIG. 6 is explained in conjunction with elements from FIG. 1, FIG. 2, FIG. 3, FIG. 4, and FIG. 5. With reference to FIG. 6, there is shown a block diagram 600. The exemplary operations of the block diagram 600 may be performed by any computing system, for example, by the system 102 of FIG. 1, by the processor 114 of FIG. 1, or by the processor 202 of FIG. 2.

In FIG. 6, there is shown an interview and candidate screening process, which may be implemented by use of the ECS model 110. The candidate screening may be performed in sequential steps by the disclosed system 102. For example, the ECS model 110 may perform the candidate screening in three stages, like resume screening, Chatbot text-based interview, and one-way video interview as shown in FIG. 6. In the resume screening (for example resume screening 602 process in FIG. 6), the processor 202 may input resume of one or more selected candidates and estimate the candidate's skill and qualifications. The candidates may be selected based on selection criterion (like availability, salary range, education background, or security clearance) as described, for example, in FIG. 5. The processor 202 may be configured to parse the input resumes to estimate the candidate skills and qualifications (for example key qualification) as shown in FIG. 6 as parse key qualification 604 process. The processor 202 may assess skills and qualifications against the job requirements to further identify skill gaps of the selected candidates and further proceed to later screening stages of the candidate screening process. The identification of the skillset gap information may be performed by skillset estimation 606 process as shown in and described with respect to FIG. 6. The determination of the skill requirement may be performed by the JRE model 106 as described with respect to and shown in, for example, in FIG. 3. The analysis of the resumes to estimate candidate's skill and qualifications may be performed the CSA model 108 as described, for example, in FIG. 4.

In an embodiment, the processor 202 may receive the skill requirement information and the first score information (related to the skill requirement information) from the JRE model 106. The processor 202 may be further configured to receive the candidate skill information and the second score information (related to the candidate skill information) from the CSA model 108. The processor 202 may be further configured to determine skillset gap information based on the received outputs from both the JRE model 106 and the CSA model 108. The skillset gap information may indicate skillset gap of a candidate against the job requirement (i.e. extracted by the JRE model 106 based on the set of job descriptions as described, for example, in FIG. 3). The outputs from both the JRE model 106 and the CSA model 108 may refer to the skill requirement information, the first score information, the candidate skill information, and the second score information. The determined skillset gap information may facilitate the ECS model 110 for a first stage of the automated screening of the candidates. Therefore, the ECS model 110 may automatically receive the outputs of the JRE model 106 and the CSA model 108 for training and screening of the candidates. In an embodiment, the skill requirement information and the candidate skill information from the JRE model 106 and the CSA model 108 may be considered as a third set of external training signals to train the ECS model 110.

In an embodiment, the processor 202 of the disclosed system 102 may further conduct a chatbot text-based screening process (like a Chatbot text-based interview 608 process shown in FIG. 6). The processor 202 may be configured to determine whether the selected candidates satisfy or meet the requirement criteria based on the skillset gap information determined at the first stage of the candidate screening process performed by the ECS model 110 in FIG. 6. The processor 202 may automatically perform the chatbot text-based screening for the selected candidates who satisfies or meets the requirement criteria as shown, for example, in FIG. 6.

The Chatbot text-based screening may include an interview question generator (like an interview question generation 610 process). The processor 202 may control the interview question generator to determine a set of questions to be covered during the Chatbot text-based interview with the selected candidates. In an embodiment, the processor 202 retrieve the set of questions from the memory 204 or from the server 116. The processor 202 may select the set of questions based on the skill requirements determined by the JRE model 106 and/or based the candidate skill information determined by the CSA model 108. The interview question generator may consist of a pre-populated question bank (such as question bank 612 shown in FIG. 6) and an interface which may allow a user (such as hiring managers) to contribute additional questions and requirements, which may be referenced for future interviews. In an embodiment, the processor 202 may control or include an AI generative transformer-based architecture to customize interview questions for the chatbot text-based screening. The processor 202 may optimize or customize the interview questions based on different factors, but are not limited to, skill requirements, candidate's skill and qualifications, skillset gap information, past interview feedback from same or other candidates, job responsibilities, and the like. The processor 202 or the ECS model 110 may select the interview questions to assess specific gaps and reinforce candidate's past skill assessments. The processor 202 may input the interview question generator with a particular skill requirement or qualification to probe the candidate, and the interview question generator may generate a unique and personalized interview questions for the candidate for the chatbot text-based screening. The interview question generator may have access to a database of questions (i.e. such as a question bank 612) where each question may be tagged with, but is not limited to, a keyword, or particular skill, or qualification, and a difficulty level.

In an embodiment, the processor 202 may control the ECS model 110 to retrieve the set of questions based on information about at least one of candidate past information, the skill requirement information, or complexity level information related to the skill requirement information. The candidate past information may indicate which questions or topic have not been considered during past interviews. The skill requirement information may allow the retrieval of the relevant questions which may match the skill requirement (for example relevant questions to be selected for a particular software language or a particular responsibility, like sales, operations, etc.). The complexity level information may indicate a level of difficulty for the question. The level of difficulty may depend on different factors, but is not limited to, time period to complete the hiring process, financial budget (salary range), responsibilities, relevant experience of the interviewed candidate, past interview of the candidate, and the like. In an embodiment, the processor 202 may refine (in terms of quality and difficult scores) the set of questions in the question bank based on user feedback (either received from hiring manager, interviewers, or candidates) received over time. The processor 202 may be configured to re-train or re-calibrate the ECS model 110 based on such inputs about the feedbacks on the set of questions. In an embodiment, the interview question generator may include a generative pre-trained transformer model to rephrase one or more questions of the set of questions. This may enable customization of questions for candidate's specific skillset and further reduce cheating (through look-up of questions online). For example, a question related to demonstration of a software concept may be generated for multiple languages with nearly identical meaning. In an embodiment, the processor 202 may train the ECS model 110 based on different set of questions to be covered during the candidate screening process. In another embodiment, the processor 202 may train the ECS model 110 to select the relevant set of questions based on the skill requirement information (for example with high score and/or priority) and the candidate skill information output by the JRE model 106 and the CSA model 108, respectively.

In an embodiment, the processor 202 may be configured to transmit the set of questions to a candidate device related to a candidate under the candidate screening process. In an embodiment, the processor 202 may send at least one question, wait for candidate's response, and further transmit another question based on response received for the previous question. Examples of the candidate device may include, but are not limited to, a mobile phone, a desktop computer, a laptop, or any other computation device. The processor 202 may be further configured to receive at least one response or a set of responses from the candidate device based on the transmitted one or more selected questions. In an embodiment, the processor 202 or the ECS model 110 may analyze or interpret the response of the candidate to determine whether the received response is correct or meets the expectation over a predefined threshold based on the transmitted question or skill requirements. As shown in FIG. 6, the disclosed system 102 or the ECS model 110 may include a response parser (i.e. related to response parsing 614 process). The processor 202 may control the response parser to analyze the set of responses (i.e. candidates answers) received from the candidate device. The received response may be in plain textual form or may in number form (for example in case of multiple choose questions). The processor 202 may control the response parser to parse the candidate responses and match them with expected responses stored in the question bank. The response parser may retrieve the expected response from the question bank and match with the received response for recently transmit question. In an embodiment, the processor 202 may input the candidate's response as well as the original question (i.e. recently transmitted) to the response parser. The response parser in the ECS model 110 may be trained to analyze the questions and related response to assess the quality of the response. The assessment may be a continuous score, or a categorization of the response into discreet quality levels (e.g., strong or weak response). Therefore, the processor 202 may be configured to control the response parser of the ECS model 110 to determine candidate assessment information for the candidate based on the received set of responses, where the candidate assessment information may indicate the quality of the responses. In an embodiment, the candidate assessment information may also include the skillset gap information (i.e. determined at initial phase of the candidate screening process based on the outputs of the JRE model 106 and the CSA model 108).

The ECS model 110 may be implemented using a combination of multiple systems or processes. Firstly, based on a keyword matching process, where there may be presence of a certain predefined set of keywords in the candidate response. The processor 202 and/or the response parser may determine the response's correctness based on how many of such keywords are found in the candidate response. Secondly, the ECS model 110 may include encoder-only transformer model (not shown) and a single-layer classifier network (not shown). The encoder-only transformer model may be configured to encode both the question and the received response and provide the output to the single-layer classifier network. The single-layer classifier network may be configured to provide an output as a one-hot vector categorization of the response as strong or week. In an embodiment, the encoder-only transformer model may encode the question, the received response, and a reference “golden” response (i.e. correct response) and provide the output to the single-layer classifier network of the ECS model 110. Such implementation has an advantage of providing a reference response to serve as a point of comparison to assess correctness. In an embodiment, the processor 202 may further refine the output of the response parser through user inputs which may specify if the received response is strong or weak. Such user actions may act as the training signal to the ECS model 110, which may be refined for every user rating of a question. In an embodiment, the ECS model 110 may be trained based on the set of questions and the set of responses (i.e. as the third set of external training signals) for variety of skill requirements. In an embodiment, the processor 202 may train the ECS model 110 based on the performance feedback information (i.e. past performance feedback of the interview process or related to on-job work) of same or different candidates. For example, during the interview process, the set of questions were selected to test C/C++ programming language skills, however the interview performance feedback indicates that the poor review for the candidates. In such case, the processor 202 may determine certain training signals (for example related to wrong selection of questions or incorrect interpretation of the response) and train the ECS model 110 based on such training signals. The performance feedback information may be received from the PI model 112 (as described, for example, in FIG. 7) and may be considered as the third set of external training signals or a feedback training signals received from the PI model 112. Such performance feedback information may be related to performance feedback of the hired candidate during work. Therefore, the well-trained ECS model 110 may closely collaborate with other AI models of the disclosed system 102 to handle candidate screening accurately.

In an embodiment, the processor 202 of the disclosed system 102 may further conduct the one-way video interview (like a one-way video interview 616 process shown in FIG. 6). Similar to the chatbot text-based screening, the processor 202 may conduct video based interview for the candidate using the ECS model 110. The processor 202, via the ECS model 110, may control an imaging device (for example a camera) associated with the disclosed system 102 to capture media content related to an assessment of the candidate. In some embodiments, the one-way video interview may be conducted in continuation to the determination of the skillset gap information (i.e. first stage of the candidate screening process) and to the chatbot text-based screening (i.e. second stage of the candidate screening process). The media content may relate to video conference automatically conducted between AI enabled system 102 and the candidate. The video conference may include the set of questions and the set of responses verbally provided by the candidate. The media content may be related to a video recording of such video conference. The processor 202 may be configured to store the captured media content in a recording database 618 shown in FIG. 6.

The processor 202 may be configured to control the ECS model 110 to analyze the media content for the set of questions and the set of responses included in the media content. For the analysis, the processor 202 may control an audio transcription process (such as audio transcription 620) to convert audio content into textual content. The audio transcription process may convert speech content of the candidate into the textual content for further analysis of the responses. In an embodiment, for the audio transcription process, the ECS model 110 may include standard automatic speech recognition (ASR) models based reinforcement learning techniques, such as LSTM neural networks or hidden Markov models. Such models may include standardized sample rate and fixed bit resolution audio sequence, and output a transcription of interview discussion with timestamps.

As described with respect to the chatbot text-based screening, the processor 202 or the ECS model 110 (using the response parser) may analyze the textual content (i.e. either based on keyword matching, based encoder-only transformer model, or the combination). In addition to the analysis of the media content to determine the candidate assessment information, the processor 202 (using the ECS model 110) may determine and review behavior information of the candidate during the video based interview. The behavior information may indicate the behavior of the candidate, which may relate to information about face expressions, nervousness, confidence, honesty, dishonesty, misleading, manipulating, and the like about the candidate. In some embodiments, the processor 202 may input user inputs (from example from hiring manager or professional expert) to confirm the determined behavior information. Similar to the chatbot text-based screening, the processor 202 may select the relevant questions from the question bank and include the selected question for the video interview with the candidates. In an embodiment, the processor 202 may parse the received media content for the analysis of candidate's response, and further determine the behavior information and the candidate assessment information based on the parsed media content and the retrieved set of questions.

Based on the conducted video interview, the processor 202 may determine the candidate assessment information, the skillset gap information, and the behavior information of the candidate. In other words, the processor 202 may determine or confirm the candidate's expertise in light of the skill requirement and the candidate's skills indicated by the resume. In an embodiment, the ECS model 110 may include a computer vision model (such as convolutional neural network or a pre-trained CV foundational model, such as ResNet-50) that may receive the media content and determine whether the candidate may be manipulating the interview system in any way. For example, the computer vision model may analyze the candidate using gaze detection or facial analysis to determine if the candidates are reading off-screen and further include such results in the candidate assessment information. Therefore, based on multiple stages candidate screening process, the disclosed system 102 may utilize plurality of AI models 104 to conduct an exhaustive, accurate, and bias free screening process. The processor 202 (using the ECS model 110) may aggregate outputs of the skillset gap information, the chatbot text-based screening, and the one-way video interview. Such aggregation may be referred as skillset fit estimation 622 in FIG. 6. The processor 202 may be configured to determine candidate's feedback information (i.e. performance feedback for the interview process) based on the determined skillset gap information, the behavior information, and the candidate assessment information. Such aggregated outputs with the detailed screening process using a plurality of AI models 104 may provide the accurate candidate's feedback information (or performance feedback as described in FIG. 4).

FIG. 7 is a block diagram that illustrates exemplary operations for performance interpretation (PI) model, in accordance with an embodiment of the disclosure. FIG. 7 is explained in conjunction with elements from FIG. 1, FIG. 2, FIG. 3, FIG. 4, FIG. 5, and FIG. 6. With reference to FIG. 7, there is shown a block diagram 700. The exemplary operations of the block diagram 700 may be performed by any computing system, for example, by the system 102 of FIG. 1, by the processor 114 of FIG. 1, or by the processor 202 of FIG. 2.

In an embodiment, the processor 202 may be configured to control the PI model 112 to receive performance feedback information. The performance feedback information may indicate performance of a hired candidate during the work or for a particular time period (like 6 months, 1 year, etc.) spent by the hired candidate in an organization. The processor 202 may be configured to trigger a performance review (as shown in FIG. 7) for the candidate. Based on the trigger, the PI model 112 may receive the performance feedback information about the candidate. In an embodiment, the processor 202 may generate a performance review prompt or a request (as per performance review input 702 in FIG. 7), via the I/O device 206. The performance review prompt may sent review requests to different computation devices (like computer, laptop, or phone) related to different seniors or managers of the candidates for whom the performance review may be required. In an embodiment, the processor 202 may receive the performance feedback information based on a freeform feedback (i.e. as freeform feedback 706 in FIG. 7), where the seniors or managers may submit the performance feedback about the candidate in a textbox format. In such case, the performance feedback may be general form (or plain text form) where the seniors or managers may provide overall write-up about the performance of the candidate. The write-up may include information about, but is not limited to, evaluation guidelines, key performance indicators (KPIs), candidate's ratings, KPI-based feedback or data points, a behavioral feedback, new expectations or targets for near future, and the like. In an embodiment, the processor 202 may receive the performance feedback at regular intervals or events (for example, end of calendar/financial year, end of contract, quarterly, half-yearly, and the like). In an embodiment, the PI model 112 may include an AI based parser (for example AI based skill estimator 712 in FIG. 7), which may parse and analyze textual information included in the freeform feedback to determine information about any additional skill for the candidates. Such information (as feedback training signals) may be provided to other AI models (like the JRE model 106, the CSA model 108, and the ECS model 110) of the disclosed system 102 for further re-training and re-calibrations of other AI models of the disclosed system 102. For example, for similar types of candidates, the CSA model 108 may be re-calibrated to determine updated candidate skill information based on the information about additional skill received from the PI model 112. Similar to other AI models of the system 102, the PI model 112 or AI based parser may also include an encoder-only transformer model (not shown), where a first stage of the encoder-only transformer model may be an identification of keywords in the textual information of the received freeform feedback, and a second stage of the encoder-only transformer model may include an assessment of the keywords through a regression model where associated skills are mapped to values.

In another example, the performance feedback information may be received in the form of general performance survey 708 (shown in FIG. 7), where the feedback may be collected in form of predefined questionnaire as the performance survey 708. The performance survey 708 may include fixed set of questions and may related to multiple choice responses to be selected by the seniors or managers. In another example, the performance feedback information may be collected based on requirement based questions 710 (shown in FIG. 7). The processor 202 may control the PI model 112 to receive the skill requirement information or the set of job descriptions from the JRE model 106 (as job description and requirement 704 in FIG. 7) to further generate a performance related questions related the skill requirement information. In such case, a list of skill requirements provided by the job description or the JRE model 106 for a particular role, may serve as a baseline reference value for the PI model 112. For example, in case the skill requirement is for C/C++ programming language, then the performance related questions may be formed to receive the performance feedback information for the same skill (like C/C++ programming language). In another example, the PI model 112 may generate the performance related questions for different skills indicated based on the skill requirement information (i.e. indicating multiple skills) received from the JRE model 106. In an embodiment, the PI model 112 may further execute a skillset aggregation process (i.e. skillset aggregation 714 in FIG. 7). In such process, the processor 202 may train the PI model 112 to aggregate or combine the additional skill determined by the AI based skill estimator 712 with the skills indicated in the performance feedback information related to the general performance survey 708 and the skills indicated by other AI models (like the skill requirement information indicated by the JRE model 106 and the candidate skill information indicated by the CSA model 108).

In an embodiment, the processor 202 may be configured to control the PI model 112 to further determine performance score information based on the received performance feedback information (i.e. received in form of freeform feedback, performance survey, and/or skill based performance feedback). In an embodiment, the processor 202 may control the PI model 112 to determine the performance score information based on the combined performance feedback information for the skills aggregated by skillset aggregation process of the PI model 112. The performance score information (i.e. related to candidate performance rating) may be provided for a particular skill or as overall performance. The processor 202 may be configured to train the PI model 112 based on the performance feedback information as a fourth set of external training signals. As performance feedback information can also be in freeform or the performance survey, the PI model 112 may be trained to parse and/or interpret the received performance feedback information and provide a summary of manual inputs provided as the performance feedback information. The PI model 112 may identify additional skills or assess specific skills and qualifications about the candidates based on such parsing and/or interpretation. In an embodiment, the processor 202 may train the PI model 112 on manual annotations (as the fourth set of external training signals) which may be interpreted to determine the performance feedback information related to different skills output from the JRE model 106 and/or the CSA model 108. In some embodiments, the PI model 112 may be trained to provide the performance feedback information and/or the performance score information based on key performance indicators (KPI) or a target set for different skills for a candidate. For example, for a team leader with team management skills, a KPI is set to provide a revenue for $10,000 or above per month. In such case, the PI model 112 may output the performance feedback information considering the set KPI or targets. The PI model 112 may be further trained to indicate the association between the performance feedback information and the performance score information which may indicate a performance rating for a candidate based on the performance feedback received for different skills defined by the job descriptions or the JRE model 106 or defined by the candidate skill information indicated by the CSA model 108. Therefore, the PI model 112 may be trained based on outputs or feedback training signals related to the JRE model 106 and the CSA model 108.

In an embodiment, the processor 202 may be configured to provide or input the performance feedback information and the performance score information (i.e. performance rating) to other AI models. For example, as described in FIG. 4, the CSA model 108 may receive the performance feedback (i.e. as the second set of feedback training signals) from the PI model 112 to train or calibrate/refine the CSA model 108. The received performance feedback information may facilitate the trained CSA model 108 to determine candidate's skill or qualifications based on candidate's resumes. The performance feedback information (i.e. performance review 718 in FIG. 7) may include, but is not limited to, performance review for a particular skill, performance review score, or review date. The performance feedback information may be related to the performance review 414, for example, shown in FIG. 4. The processor 202 may receive the performance feedback information from the trained PI model 112 to further train the CSA model 108 based on different situations of training signals, such that an accuracy of output or predictions performed by the CSA model 108 may increase. Similarly, the processor 202 may be configured to control the PI model 112 to provide the performance feedback information and the performance score information to the ECS model 110 for re-training and re-calibration based on different hiring situations and events. As described, for example, in FIG. 6, the ECS model 110 may receive the performance feedback information for training and re-calibration.

In an embodiment, the PI model 112 may act a classification model, where the PI model 112 may be configured to provide a positive response or a negative response about a particular set of skills, rather than output a specific rating output (like the performance score information). In some embodiments, the classification model may provide three different output classes, for example, skill is met, skill is not met, or a neutral output. In such case, the PI model 112 may not be trained to provide subjective feedback or any specific score (for example 6.0 points out of 10 for a skill). In an alternative embodiment, the PI model 112 may determine the positive or negative response in addition to the determination of the performance score information (i.e. candidate's ratings). In such a case, the positive/negative response may act as a sentiment signal, where the performance score information for a particular skill (relative to the job description) may increase for the positive response/feedback and decrease for the negative response/feedback.

FIG. 8 is a block diagram that illustrates exemplary operations for execution and calibration of the plurality of AI models of the system of FIG. 1, in accordance with an embodiment of the disclosure. FIG. 8 is explained in conjunction with elements from FIG. 1, FIG. 2, FIG. 3, FIG. 4, FIG. 5, FIG. 6, and FIG. 7. With reference to FIG. 8, there is shown a block diagram 800. The exemplary operations of the block diagram 800 may be from 802 to 808 and may be performed by any computing system, for example, by the system 102 of FIG. 1, by the processor 114 of FIG. 1, or by the processor 202 of FIG. 2.

At 802, a plurality of artificial intelligence (AI) models 104 may be trained. In an embodiment, the processor 202 may be configured to train each of the plurality of AI models 104 of the system 102. The plurality of AI models 104 may include, but is not limited to, the JRE model 106, the CSA model 108, the ECS model 110, and the PI model 112. Details of training each of the JRE model 106, the CSA model 108, the ECS model 110, and the PI model 112 are provided, for example, at FIGS. 3-7.

At 804, candidate hiring score information may be generated. In an embodiment, the processor 202 may apply the trained plurality of AI models on a plurality of hiring events related to one or more candidates which are to be hired. For the application of the trained plurality of AI models 104, information about the plurality of hiring events may be input to the plurality of AI models 104. For example, the JRE model 106 may input the job description, the CSA model 108 may input the candidate's resume, the ECS model 110 may conduct a candidate screening interviews and PI model 112 may receive skills and qualifications from other AI models to capture performance feedback for other AI models, as described in FIGS. 3-7. Various inputs provided to the AI models, output generated from the AI models, and different hiring stages may be considered as the plurality of hiring events for one or more candidates. The processor 202 may execute the trained plurality of AI models 104 (with a first accuracy level) on information related to such plurality of hiring events.

In an embodiment, the processor 202 may be configured to control the plurality of AI models 104 to generate the candidate hiring score information which may indicate a score level during hiring of a particular candidate. The score level may indicate a hiring decision for the candidate taken automatically by the disclosed system 102 using the trained plurality of AI models 104. The processor 202 may input different information in each of the trained plurality of AI models 104 (for example job description in the JRE model 106, candidate resume in the CSA model 108, interview-related information (like skillset gaps, questions, response, performance feedback, etc.) in the ECS model 110, and on-job performance feedback of similar past candidates in the PI model 112) to generate the candidate hiring score information. Based on the candidate hiring score information, the disclosed system 102 may determine whether the candidate can be hired or not for the defined job requirements.

In an embodiment, the processor 202 may execute each of the trained plurality of AI models 104, where the plurality of AI models 104 may provide the first accuracy level to output the candidate hiring score information or to handle different hiring events in real-time. In an embodiment, the processor 202 may control the JRE model 106 such that an output result of the JRE model 106 may be provided or utilized by other AI models of the plurality of AI models 104. For example, as described in FIG. 4, the processor 202 may control the CSA model 108 to receive the job skill requirements from the JRE model 106 to determine (or compare with) the candidate skill information. Further, based on the output result from the JRE model 106, the processor 202 may train the CSA model 108. In another example, as described in FIG. 5, the processor 202 may utilize the output result received from the JRE model 106. The processor 202 may utilize the output results of the JRE model 106 to filter or rank candidates based on skill requirements. In another example, as described in FIG. 6, the processor 202 may control the ECS model 110 to determine the skillset gap information based on the skill requirement information and the first score information received from the JRE model 106. Further, the processor 202 may control the ECS model 110 to select or customize the set of relevant interview questions based on the skill requirement information received from the JRE model 106. In another example, as described in FIG. 7, the processor 202 may control the PI model 112 to determine the performance related questions and output the performance rating related to the skill requirement information received from the JRE model 106. Therefore, the well-trained JRE model 106 may closely collaborate with each of the other AI models 104 to handle candidate screening accurately. Such collaboration may facilitate intelligent integration of different AI models with the JRE model for the effective determination of the skills and the screening of the candidates

At 806, periodic calibration of the CSA model 108 may be performed. In an embodiment, the processor 202 may control the periodic calibration or re-training of the trained CSA model 108 for the plurality of hiring events. Such plurality of hiring events may be related to one or more candidates (such as new candidates) on which the trained plurality of AI models 104 are applied. The processor 202 may calibrate or re-train different models (for example the CSA model 108 and the JRE model 106) based on the plurality of such hiring events related to the new candidates. Such calibration or re-training may be based on the second set of feedback training signals received from different AI models (like JRE model 106, the ECS model 110, and the PI model 112). For example, as described in FIG. 4, the CSA model 108 may receive information about the skill requirements from the JRE model 106 to screen the candidate's resume and determine the candidate skill information in lieu of the skill requirement information indicated by the JRE model 106. For different hiring events (for example for new job descriptions received by the JRE model 106), the processor 202 may control the JRE model 106 to provide new skill requirement information to the CSA model 108 and further calibrate or re-train the CSA model 108. Similarly, as described in FIGS. 4 and 6, the CSA model 108 may receive information about hiring decisions and/or interview feedbacks (as the second set of feedback signals) from the ECS model 11. Similarly, as described in FIGS. 4 and 7, the CSA model 108 may receive information about performance feedback for the on-job work (as the second set of feedback signals) from the PI model 112. For different hiring events for the ECS model 110, or during candidate interview process (as described in FIG. 6), or for the PI model 112 (as described in FIG. 7), the processor 202 may periodically calibrate or re-train the CSA model 108. For example, in case based on the resume screening, the CSA model 108 does not suggest a particular skill in the candidate's resume, however the interview feedback or past feedback (either received from the ECS model 110 or the PI model 112) suggests such skill as positive result, such mismatch (as the ground truth) may be re-trained or calibrated in the CSA model 108. Further, such calibration may re-train the CSA model based on new data or new hiring situations/events learned by the plurality of AI models 104 when applied for one or more new candidates (for whom the plurality of AI models 104 may not be trained). Such periodic calibration and re-training of the CSA model 108 based on different or new hiring events (i.e. occurs during the training and operations of other AI models) may enhance the accuracy of the CSA model 108. Such real-time and periodic calibration may further reconfigure one or more candidate assessment criterions of the CSA model 108 based on which the CSA model 108 may assess the candidate resumes and determine the candidate skill information with enhanced accuracy. Further, various information (like feedback signals) received from different AI models may facilitate the CSA model 108 to effectively integrate with other AI models and re-calibrate for new candidates or new-hiring events experienced at different AI models.

At 808, a calibration loop between the CSA model 108 and the JRE model 106 may be controlled. In an embodiment, the processor 202 may further calibrate or re-train the JRE model 106 based on different calibration events of the CSA model 108. As described, for example, at 806 in FIG. 8, the processor 202 may control the calibration of the CSA model 108 based on the second set of feedback training signals received from different AI models (such as the JRE model 106, the ECS model 110, and the PI model 112). Based on such calibration events of the CSA model 108 for different hiring events/situations for new or existing candidates, the processor 202 may further calibrate or re-train the JRE model 106 to control the calibration loop between the CSA model 108 and the JRE model 106. For example, as described in FIG. 3, the JRE model 106 may receive the first set of feedback training signals from other AI models (for example the CSA model 108). For a particular event (such as for a hired candidate), the CSA model 108 may analyze the candidate skill information of the hired candidate and further provide the candidate skill information (as the first set of feedback training signals) to the JRE model 106. The processor 202 may control the JRE model 106 to determine any skill gap between the skill requirements and candidate's skills and further re-train or calibrate the JRE model 106 for any skill difference or such hiring events. In another example, the candidate skill information for the hired candidate may be utilized as a positive training signal for the JRE model as described, for example, in FIG. 3. Similarly, the processor 202 may control the CSA model 108 to determine the candidate skill information for the rejected candidates and provide such information as a negative training signal for calibration or re-training of the JRE model 106. Such feedback signals may improve the JRE model 106 towards the incorrect skill requirements formed at initial stages. For example, if the JRE model 106 initially generates certain skill requirement information and the candidates screened based such skill requirement information are rejected, the processor 202 may determine that the JRE model 106 has incorrectly estimated the skill requirement information and further require re-calibration based on the feedbacks received from the other AI models (like the CSA model 108) for a particular job posting or requirements. Such recalibration of the JRE model 106 may improve the accuracy of the determination of the skill requirement information based on actual job description and real-time candidate assessment. Therefore, for different calibration events of the CSA model 108 for variety of real-time hiring events, the processor 202 of the disclosed system 102 may control the calibration loop between the JRE model 106 and the CSA model 108. Such calibration loop may avoid any mismatch between the skills estimated from the job descriptions by the JRE model 106 and skills estimated from the candidate's resume by the CSA model 108 on real time basis. Such real-time and intelligent interaction/integration between well-trained AI models (such as the CSA model 108 and the JRE model 106) and further calibration may enhance the overall accuracy of the plurality of AI models 104 (for example from the first accuracy level to a second accuracy level which may be higher than the first accuracy level) to automatically handle a recruitment pipeline for an organization effectively. Further, such calibration loop between the JRE model 106 and the CSA model 108 may further enhance the accuracy of the candidate ranking (i.e. candidate with matched skills, overqualified, or underqualified) based on combined outputs of the JRE model 106 and the CSA model 108, as described, for example, in FIG. 5.

The disclosed system 102 may represent a significant advancement in the field of recruitment and human resource management. The real-time calibration of each AI models based on different hiring events and feedbacks from other AI models may enhance the accuracy of the plurality of AI models 104, where the plurality of AI models 104 are trained based on exhaustive training data and hiring situations. In typical hiring process which may be performed manually, such real-time calibration based on exhaustive hiring situations may not be possible or may be tedious. Further, the disclosed system 102 may incorporate a dynamic coordination and integration between different AI models related to different stages of the hiring process. For example, but is not limited to, the JRE model 106 is trained on estimation of skill requirements, the CSA model 108 is trained on assessment of candidate's skill, the ECS model 110 is trained on handling candidates assessment based on detailed interview process, and the PI model 112 model is trained on execution/capture of performance feedback. Each of the plurality of AI models 104 are trained and calibrated based on different set of external training signals as well as feedback signals received from other AI models. Such dynamic coordination and interaction between AI models may reduce any bias and increase fairness in the hiring process. In contract, the typical hiring solution may be dependent on human with subjectivity and biases.

Further, the plurality of AI models 104 may be trained and calibrated on a large amount of training data related to different skills (or jobs) of variety of technical, operational, and business domains. Such exhaustive training and calibration may allow the disclosed system 102 to efficiently take hiring decisions with high accuracy, reliability, and fairness for almost all the domains and business. In contract, in prior hiring solutions (like human-based), such exhaustive knowledge about variety of domains and related skills may be cumbersome. Further, the disclosed system 102 includes various large language models (LLM) and scoring methodologies, which may allow easy interpretation of context in different job descriptions and/or resumes. Such accurate interpretation and scoring by the plurality of AI models 104 of the disclosed system 102 may allow precise assessments with improved fairness at different hiring stages and further reduce hiring related frauds. Certain AI models of the disclosed system 102 may be exhaustively trained for variety of data sources which may store large amount of information about the candidates. For example, in addition to resume, the CSA model 108 may be trained on other data sources which may store information, prior history, publications, or records about candidates, their skills, and corresponding skill levels. The disclosed system 102 may allow the comprehensive training of the AI models and assessment of the candidates based on such large amount of data (i.e., millions of records) retrieved from variety of such data sources. This may further enhance the accuracy and correctness of candidate's assessment in the field of recruitment and human resource management. Further, the disclosed system 102 allows the plurality of AI models 104 to dynamically adapt to individual hiring events by learning from user interactions, hiring decisions, and performance feedback over time. Rather than relying on a static model, the disclosed system 102 refines itself (using real-time calibration described, for example, in FIG. 8) based on actual user behavior, including candidate assessments, hiring patterns, and job requirement adjustments. The plurality of AI models 104 trained and calibrated on organization's historical hiring data (including job requirements and candidate hiring/feedback outcomes), may allow improvement in hiring accuracy and efficiency for future candidate evaluations. Further, results of the disclosed system 104 (or of individual AI model) may evolve over time, aligning more closely with an organization's actual hiring standards rather than a one-size-fits-all model.

Further, scoring methodology described, for example, in FIGS. 3-5 (like related to the first score information, the second score information, ranking of the candidates) may allow conversion of candidate's skill assessment from qualitative to quantitative. For example, the conversion of candidate skill assessments from subjective, qualitative feedback into quantitative scores. Further, as described in FIG. 5, the disclosed system 102 may apply normalized scoring, including min-max scaling or transformation functions, to present candidate skills on a consistent scale for objective comparison, where qualitative feedback/information on candidate skills may be converted into a numerical score through a normalized process and the scores may be further scaled between pre-defined ranges (e.g., “0 to 1” or “−1 to 1”) to create a standard metric. Such quantitative scores (in the form of quantitative skill assessment) for each candidate may allow objective comparison across different candidates and job roles to further rank the candidates accurately and efficiently, as described, for example, in FIG. 5.

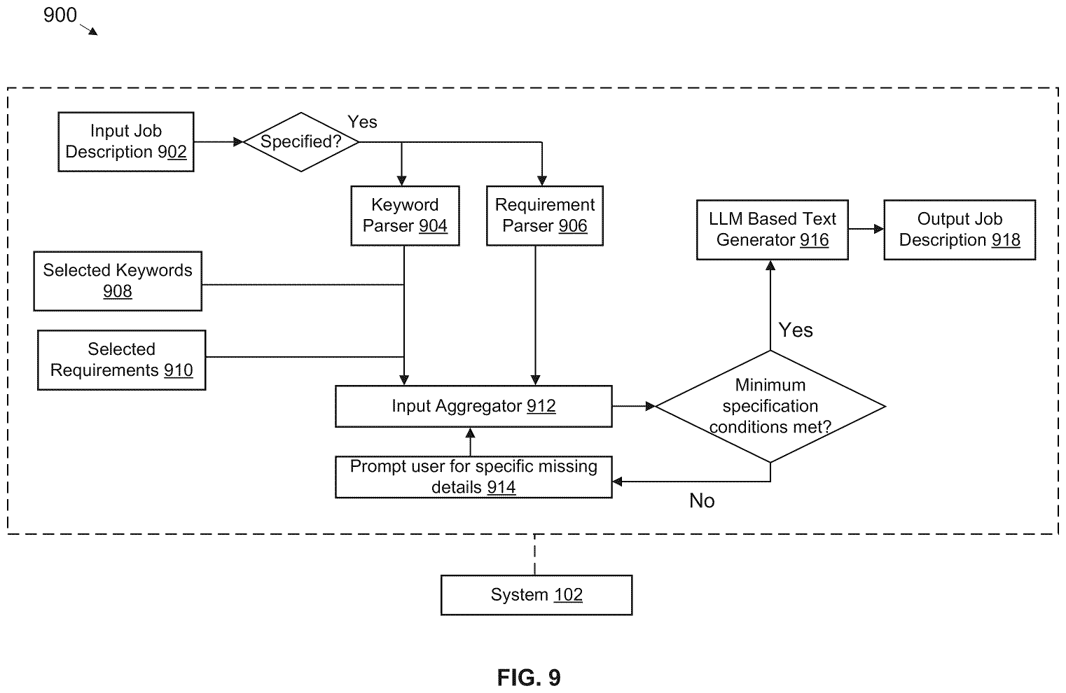

FIG. 9 is a block diagram that illustrates exemplary operations for generation of job description by the system of FIG. 1, in accordance with an embodiment of the disclosure. FIG. 9 is explained in conjunction with elements from FIG. 1, FIG. 2, FIG. 3, FIG. 4, FIG. 5, FIG. 6, FIG. 7, and FIG. 8. With reference to FIG. 9, there is shown a block diagram 900. The exemplary operations of the block diagram 900 may be performed by any computing system, for example, by the system 102 of FIG. 1, by the processor 114 of FIG. 1, or by the processor 202 of FIG. 2.

The processor 202 of the disclosed system 102 may be further configured to generate one or more job description documents. The processor 202 may be configured to receive or input information about one or more job descriptions (i.e. as per input job description 902 process). The processor 202 may receive the job descriptions, via the I/O device 206, from one or more users, for example a hiring manager, a recruitment representative, or a project manager. The processor 202 may generate the one or more job descriptions to standardize job description (JD) content and format, and further allow the hiring managers to streamline the process of submission of open roles. The received job descriptions may be in plain-text input which may be a complete job description, or a sparse description of the role and responsibilities for complete job description document to be generated. The disclosed system 102 may further include a keyword parser (such as including a keyword parser 904 shown in FIG. 9) and a requirement parser (such as including a requirement parser 906 shown in FIG. 9). The keyword parser and the requirement parser may range from simple text-based parsers to natural language processing models (e.g., bidirectional encoder representations from transformers or BERT) for keyword identification. The processor 202 may control the keyword parser and the requirement parser to determine the keywords (related to the skill requirement) in the input job descriptions. In an embodiment, the processor 202 may receive the skill requirement information (indicating the skill requirement for new jobs) from the JRE model 106 to execute operations of FIG. 9 and generate the job description documents. In an embodiment, the processor 202 may extract a predefined list of keywords and/or requirements from the input job descriptions. The processor 202 may receive and select such keywords and requirement prior to analysis of the input job descriptions (for example as per selected keywords 908 and selected requirement 910 shown in FIG. 9). The processor 202 may control the keyword parser and the requirement parser to extract the keywords and requirements in the input job description based on selected keywords and the selected requirements. In some embodiments, the processor 202 may select keywords from a finite pre-populated list, based on anticipated job requirements, common industry skills, and general concepts. Such pre-populated list may be stored on the server 116. In some embodiments, the processor 202 may send information about the anticipated job requirements, the common industry skills, and the general concepts to the server 116 to select the keywords. In certain situations, the keyword selection list may grow with custom keyword requirements received from the hiring managers or other recruitment experts, via the I/O device 206. The processor 202 or the keyword/requirement parser may execute different methods (for example variations of finite-pattern string searching algorithms, including either an Aho-Corasick algorithm or a Commentz-Walter algorithm) to determine the keywords (related to the skill requirement) from the input job descriptions. Such methods may be further optimized based on removal of keywords from the selected keywords (or a patterns list) once the keywords are found in the input job descriptions. In another embodiment, the processor 202 may implement keyword extraction as a component of a requirements extraction model (based on NLP techniques) and further compare with the pre-populated list for further refinement and categorization. In further embodiment, the processor 202 may store the determined keywords in a list, and map the list to additional relevant metrics, such as number of occurrences of the keyword to the input job description.

In an embodiment, the processor 202 may further control an input aggregator (for example including an input aggregator 912 process in FIG. 9) to aggregate the keywords determined from the input job description (i.e. in plain or free-form text) with the selected keywords and requirements. The processor 202 may further determine whether a minimum specification condition is met (or not) based on the aggregated keywords/requirements and skill requirement information provided by the JRE model 106 as shown in FIG. 9. In some embodiments, in case the minimum specification condition is not met, the processor 202 may control the input aggregator to identify gaps or missing keywords in the input job description which may be necessary for optimized generation of the job description documents. The processor 202 may further output (or prompt) such skill gaps and/or missing keywords, via the I/O device 206 to the users (such hiring managers or recruitment representatives) as shown in “prompt user for specific missing details” 914 in FIG. 9. The processor 202 may further receive the missing keywords or requirements from the user(s) until the minimum specification condition is met. The processor 202 may receive additional detail and context around the job descriptions, via the I/O device 206 from the users. In some embodiments, the processor 202 may identify the gaps or missing keywords based on predefined minimum job posting content requirements which may define a set of parameters defined for different job postings. For example, such parameters may include minimum set of defined characteristic parameters, like years of experience, a level of education, a type of degree, a location preference, etc., defined for each job description. Further, the parameters may indicate a minimum number of keywords. For example, each job description may be required to define at least one primary keyword summarizing the job posting. Further, the parameters may indicate a minimum definition of job requirements and skills of the role, with expected skill level and priority. For example, at least two key skill requirements should be defined for the role, with estimated levels/priorities. The input aggregator (as a refinement engine) or the processor 202 may compare keywords/requirements in the input job description with the minimum content requirements and generate a set of questions for the users, where each question may refer to the gaps or the missing keywords in the input job description. In an embodiment, the memory 204 or the server 116 may include such predefined set of questions to be presented to the users, via the I/O device 206 to receive information about the missing details.

In an embodiment, the system 102 may include a supervised machine learning model (not shown) that may be trained to identify missing requirements (keywords and/or requirements). The supervised machine learning model may be implemented using traditional supervised learning classifier models, such decision trees. In such case JD requirements may be encoded into a one-hot encoded vector to summarize which requirements are met or not met. An output of such model may be a similar vector to summarize the requirements that still need to be satisfied. Further, such model may be trained with two classes “good match” and “bad match” JDs, where skills and qualifications of each are pre-annotated manually or annotated using the keyword parser 904 process. The good match class may be an example, where all or most requirements are met or exceeded, and there may be evidence of a strong fit through human annotation/selection or user input through hiring/interviewing/performance assessments. The bad match class may be an example where zero or a few requirements are met, and the candidate would not be hired or considered for the position in a real-world scenario. Such a training process may translate human intuition about hiring decisions to an automated process. Further such process may be expanded by training through a regression model rather than a classification model, in which the training data itself provides normal assessment scores.

In an embodiment, the processor 202 may further generate the job description document based on inputs received from the input aggregator. In an embodiment, the generated job description document may include, but is not limited to, a summary of the job description, one or more job functions, minimum skill requirements, one or more preferred skill requirements, or a priority level of each skill requirement. In some embodiments, the generated job description document may include minimum education qualification, one or more preferred education requirements, designation related information, reporting information, career path related information, salary information, or benefits related information. The system 102 may include a LLM based text generator (such as LLM based text generator 916 shown in FIG. 9) to generate the job description document. The keywords and requirement received from the input aggregator may further include relevant metadata, such as priority, importance, strictness (minimum or preferred), etc. The pre-trained LLM-based text generator may enable the system 102 to regenerate a human-readable job description based on the input keywords and requirements. The text generator may synthesize a human readable formatted job description (JD) based on information about the received requirements and parameters. The text generator may receive a list of keywords and combination of requirements which may represent skills or qualifications. In the case of skills, the requirements may be mapped to a target skill level and in the case of qualifications, requirements may be mapped to a target value or range. The text generator may also assign each requirement with a priority, relative importance, and strictness. The processor 202 may further control the text generator, including a pre-trained generative transformer model, to assemble the received keywords and requirements into a plain-text format. The processor 202 may further tune and re-train the text generator based on different examples of JDs, in a target output format. Such examples may serve as the ground truth model output. The processor 202 may further output the generated job description document (for example as per output job description 918 in FIG. 9). The generated job description document may be output via the I/O device 206 or may be stored in the memory 204 or the server 116 for further usage (i.e. for example by the JRE model 106 for future hiring events).

In an embodiment, the processor 202 may be further configured to refine or update the generated job description document. The processor 202 may refine the generated job description document based on number of candidates matched with the generated job description document. In such case, the processor 202 may receive information from the CSA model 108, where the received information may indicate the number of candidates passed the resume screening (i.e. as per resume screening 602 in FIG. 6) and their skills (indicated in the corresponding resume) match with the skill requirement information or with the skills or qualifications indicated in the job description document. The processor 202 may perform an iterative process where the job description may be refined with goal of limiting the number of matched candidates to an ideal range. For example, if a certain job description returns a number of qualified candidates over a threshold number, the system 102 may prompt or trigger to refine the candidate search of the job description document. In an embodiment, the processor 202 may search candidates based on the generated job description document over an internet or on the server 116. The processor 202 may refine or update the generated job description document based on a number of candidates found by the search. For example, for a job description with a niche skillset, if the number of candidates are above a threshold or range (for example more than 1000 in a specific city), the processor 202 may trigger refinement or re-generation of the job description document to target most relevant candidates based on the updated job description document and optimize the recruitment time.

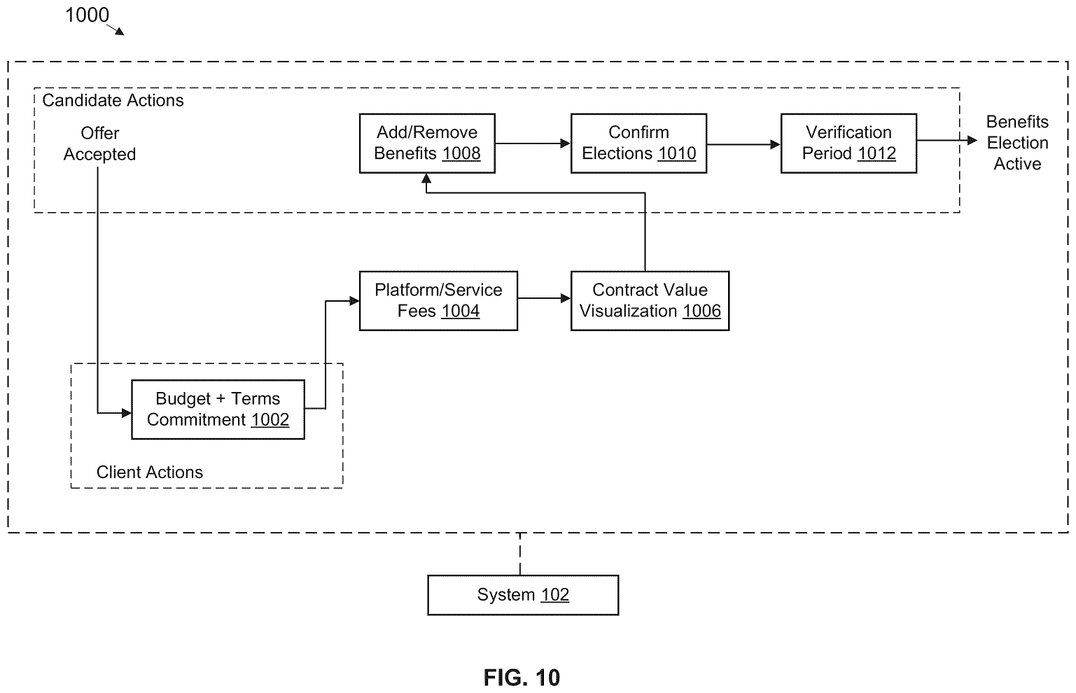

FIG. 10 is a block diagram that illustrates exemplary operations to generate candidate benefit information, in accordance with an embodiment of the disclosure. FIG. 10 is explained in conjunction with elements from FIG. 1, FIG. 2, FIG. 3, FIG. 4, FIG. 5, FIG. 6, FIG. 7, FIG. 8, and FIG. 9. With reference to FIG. 10, there is shown a block diagram 1000. The exemplary operations of the block diagram 1000 may be performed by any computing system, for example, by the system 102 of FIG. 1, by the processor 114 of FIG. 1, or by the processor 202 of FIG. 2.

In an embodiment, for the hired candidate, the processor 202 may be configured to generate an offer letter or a contract document. The offer letter may include, but is not limited, information about hiring decision, information extracted from the job description document, roles and responsibilities for the candidate, designation, department, a time period of contract, compensation details, and general terms and conditions of an organization. The processor 202 may be configured to transmit the generated to the offer letter to the candidate device (not shown) for review and acceptance/rejection of the candidate. As shown in FIG. 10, the processor 202 may receive information about the acceptance of the offer letter from the candidate device related to the hired candidate. The processor 202 may further interact with internal users (for example hiring managers), via the I/O device 206, to accept or commit the budget and terms of the contract for the hired candidate (i.e. as shown in budget+terms commitment 1002 in FIG. 10). In an embodiment, a payment model may calculate the offer for the candidate based on budget specified by the client. The total compensation to the candidate may be a fixed percentage of the budget, minus additional fees (i.e. platform/service fees 1004) related to platform options (such as allocation for performance bonus and allocation for severance).

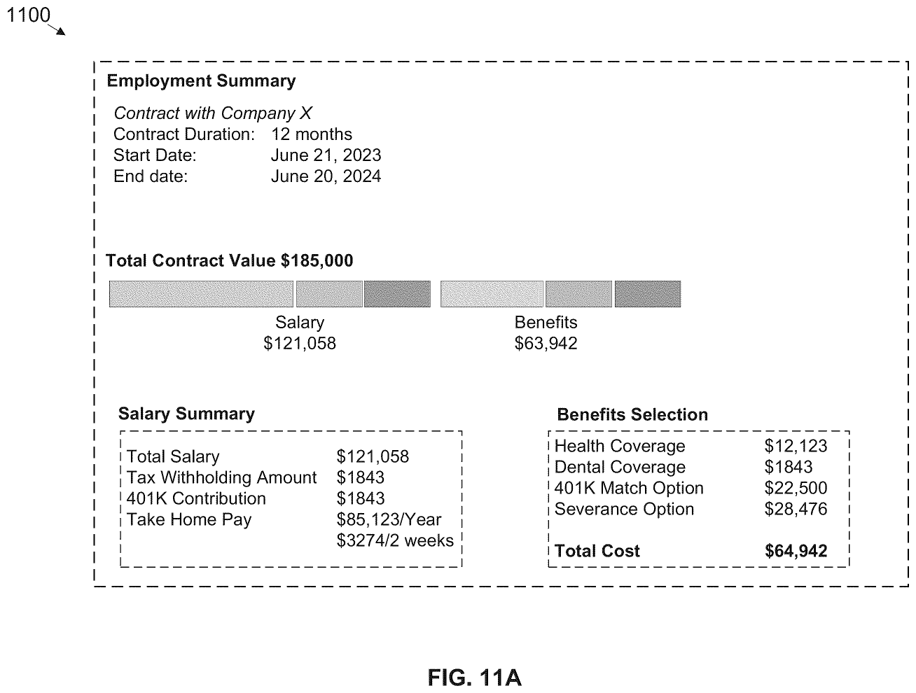

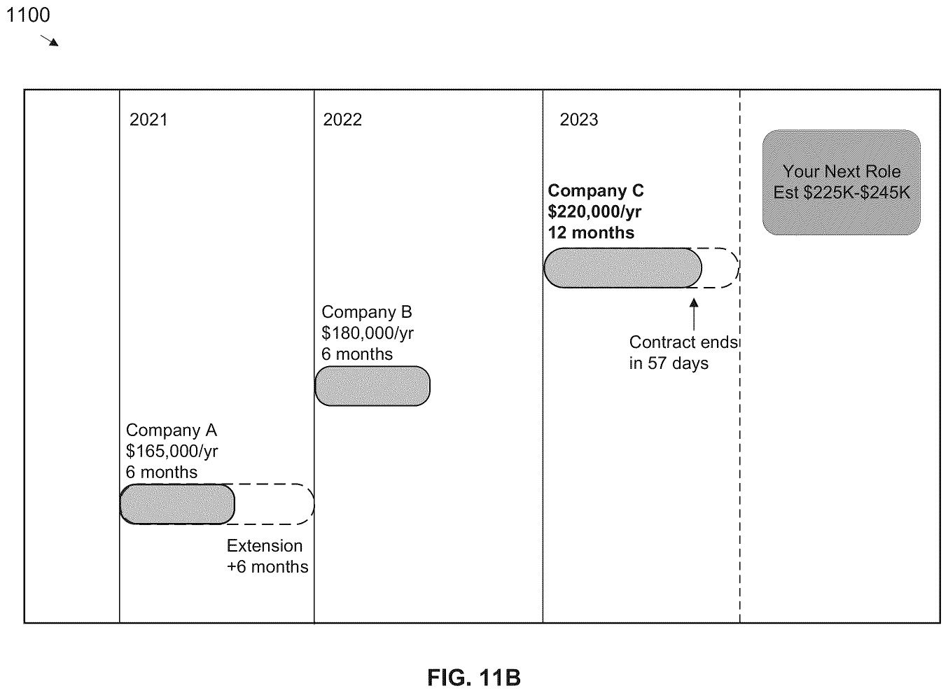

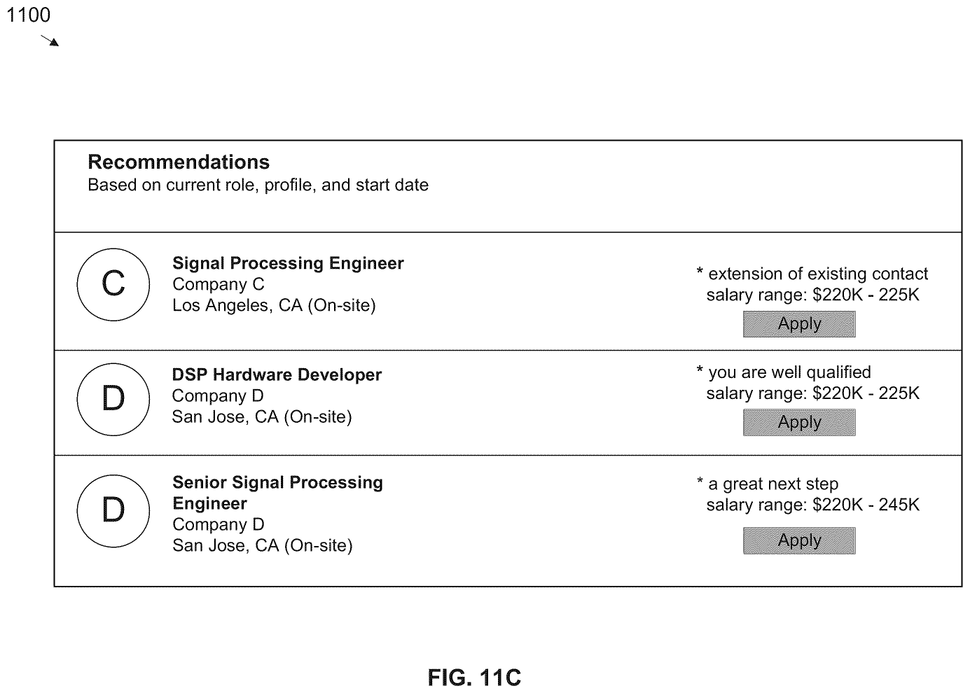

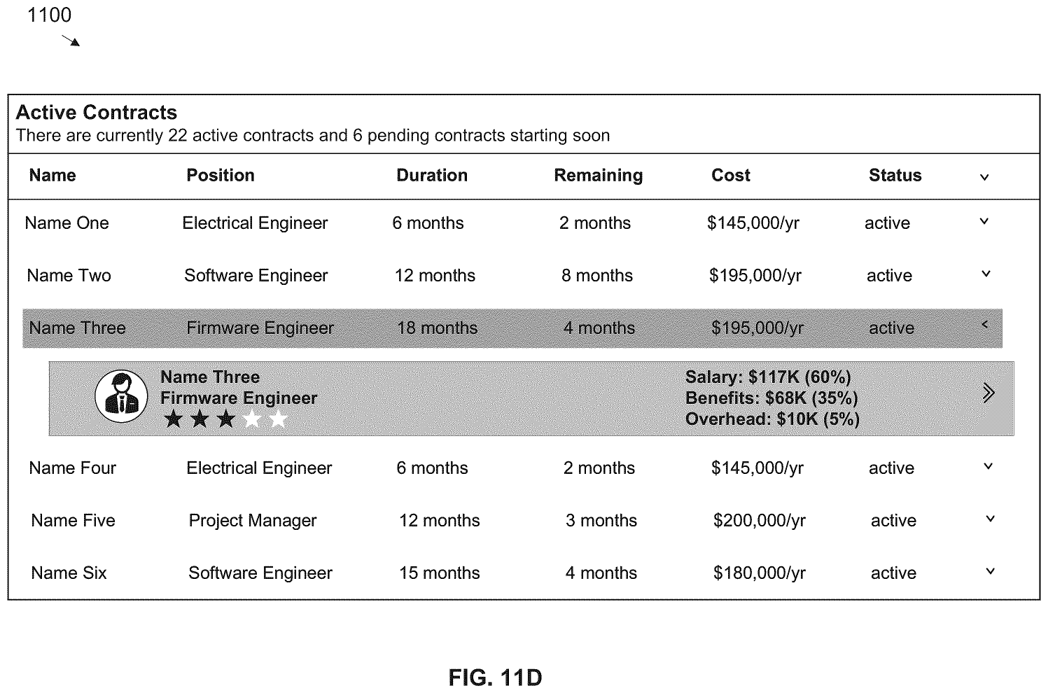

In an embodiment, the processor 202 may output different visuals (i.e. contract value visualization 1006 in FIG. 10) about the contract or offer prepared for the hired candidates. For example, as shown in FIG. 11A, the visuals may indicate a fixed salary component of the contract and a value of benefits as candidate benefit information. The processor 202 may generate the candidate benefit information based on information received from the trained plurality of AI models 104. The details of the candidate benefit information and other information about the contract are provided, for example, in FIG. 11A. In an embodiment, the disclosed system 102 may allow different users (for example hiring managers or other recruitment executives) to interact with the contract, via the I/O device 206. Such interaction may allow the hiring managers or the candidates to add or remove (i.e. add/remove benefits 1008 in FIG. 10) different benefits in the contact. The benefits may be related to, but not limited to, variable salary, bonus value, travel-related benefits, food/cafeteria services, a medical insurance, a death insurance, an accidental coverage, an annual saving, leave related benefits/policies, loan related benefits, or certification or academic benefits. In an embodiment, the processor 202 may generate the candidate benefit information based on the trained plurality of AI models 104. For example, based on the JRE model 106, the processor 202 may determine the score/priority for different skills and accordingly select a higher or lower benefit as per the skill requirement. In another example, the processor 202 may receive the interview feedback from the ECS model 110 and accordingly select a higher or a lower benefit based on the received interview feedback. A balance of cash offer (or fixed salary) and the benefits may be selected or changed based on the benefits elected. For example, the candidate may remove all benefits and get the maximum cash offer. Alternatively, the candidate may elect all benefits and get a minimum cash offer.

In an embodiment, the processor 202 may transmit the candidate benefit information (i.e. indicating different benefits elected for the candidate) to the candidate device for review or acceptance. The processor 202 may further receive a response from the candidate device, where the response may indicate one or more queries about the benefits or confirmation about the elected benefits (i.e. confirm election 1010). In some embodiments, the processor 202 may receive one or more queries to verify the period about the benefits. Based on such queries, the processor 202 may transmit a response to the candidate device and confirm/verify a period (i.e. verification period 1012) for the elected benefits. Based on the confirmation of the benefits for the hired candidates, the processor 202 may include the final benefits in the contract and/or activate the elected or confirmed benefits in a workflow of the organization for which the candidate is hired.

FIGS. 11A-11D collectively illustrate exemplary user interfaces generated by the disclosed system of FIG. 1, in accordance with an embodiment of the disclosure. FIGS. 11A-11D are explained in conjunction with elements from FIG. 1, FIG. 2, FIG. 3, FIG. 4, FIG. 5, FIG. 6, FIG. 7, FIG. 8, FIG. 9, and FIG. 10. With reference to FIG. 11A, there is shown an exemplary first user interface which may indicate a contract for a hired contract. As shown in FIG. 11A, for example, the contract may include organization details (like, but is not limited to, company's name, logo, address, contact information), a duration of the contract (in months or years), a starting date of the contract and an ending date of the contract). For example, the contract may further include information about a contract value (such as salary) which may be divided into two components such as a fixed salary component and a benefit component, as shown, for example, in FIG. 11A. As shown in FIG. 11A, for example, the benefit component may related to a monetary value which may related to different services provided by an organization for candidates, like related to bonus, insurance, food, travel, savings, etc. The benefit component may relate to the candidate benefit information as described, for example, in FIG. 10

In an embodiment, the processor 202 may output the generated contract to the users (such as internal hiring managers), via the I/O device 206 and may allow the users to interact with the output contract. The interaction may allow to change the contract value, add/remove different benefits (like add or remove insurance, bonus, travel, etc.), and change values of the selected benefits, via a user interface or the I/O device 206. As shown in FIG. 11A, the contract may further include a distribution (i.e. salary summary) of the total fixed salary for the hired candidate, where the distribution may include, but is not limited to, a total salary value, a tax value, a saving value (for example 401K contribution), and a take home pay value. Similarly, the contract may include a distribution of the selected benefits for the hired candidate. The distribution may include, but is not limited to, a health coverage value, a dental coverage value, an employer contribution towards candidate's saving (i.e. 401K Match option), or a severance or gratuity value, as shown for example, in FIG. 11A.

With respect to FIG. 11B, there is shown an exemplary second user interface which may include an employment history for an existing employee. The disclosed system 102 may display the employment history to a user (such as hiring manager) based on a request received, via the I/O device 206. The employment history may indicate, but is not limited to, information about different companies served in recent past, prior annual compensation received at the different companies, or a time period of the contract at the different companies, as shown in FIG. 11B. The employment history may further indicate information about current company. For example, as shown in FIG. 11, an existing employee may have an annual compensation of $220,000 per year, total 12 months of contract with 57 days remaining. The remaining days may alert the user (such as a hiring manager or other internal stakeholder) to either initiate a process of contract extension or a process to hire a replacement for the existing candidate. As shown, for example, in FIG. 11B, the second user interface may also suggest information about next role and estimated salary for the candidate in case of contract extension for the existing candidate. In an embodiment, the processor 202 may be configured to display the second user interface, via the I/O device 206 in a hiring event of, but is not limited to, an offer acceptance or a candidate selection, or a contract renewal.

With respect to FIG. 11C, there is a shown an exemplary third user interface which may include recommendations. In an embodiment, the processor 202 may be configured to generate recommendations for hired candidates or existing employees. The recommendations may be generated based on contract information related to the candidates. As shown in FIG. 11C, for example, the recommendations may indicate information about new job openings or opportunities based on, but is not limited to, candidate's current profile, experience, skills, compensation, and preferences (such location, job responsibility, designation, salary, available hours, etc.) In embodiment, the processor 202 may generate the recommendation for only the existing company of the candidate. In some embodiments, the processor 202 may generate the similar recommendations for other companies as well based on the contract information related to the hired candidate. As shown in FIG. 11C, the recommendation may indicate, but is not limited to, company's name, designation, location, job-type, salary range, required skills, job responsibility, job description, and UI options to apply for the new job.

In an embodiment, the processor 202 may receive information from the trained plurality of AI models and further generate the recommendations based on the information received from the trained plurality of AI models 104. For example, the processor 202 may receive information about the skills of the candidates from the JRE model 106 or the CSA model 108, information about interview feedback and behavior from the ECS model 110, information about the on-job performance feedback from the PI model 112, and so on. Based on the information received about the skills, qualifications, or feedbacks, the processor 202 may generate the recommendations about the new job postings. In some embodiments, the processor 202 may generate the recommendation for one or more users of the disclosed system 102 (for example the hiring managers or supervisors of the existing candidates).

With respect to FIG. 11D, there is shown an exemplary fourth user interface which may indicate an overview of existing hired employees to an internal user (such a hiring manager or team lead) of the disclosed system 102. The fourth user interface may indicate information about a number of active contracts that may be running in an organization (or in a particular department) or a number of new contracts starting soon. As shown in FIG. 11D, for example, the fourth user interface may indicate a list of hired candidates and information about the candidates such as, but not limited to, candidate's name, candidate's position, a total period of contract, a remaining time period before contract expiration, cost, or a status of employment. In an embodiment, the processor 202 may receive an input from the user, via the I/O device 206, to select information about a particular candidate (for example “Name three” in FIG. 11D). Based on such selection, the processor 202 may further display detailed information about the selected candidate. As shown in FIG. 11D, the detailed information may include, but is not limited to, candidate's name, candidate's position, last performance feedback/rating, fixed salary, benefit value, overhead expense for the candidate, and distribution of expenses (in percentage) borne by the company for the candidate.

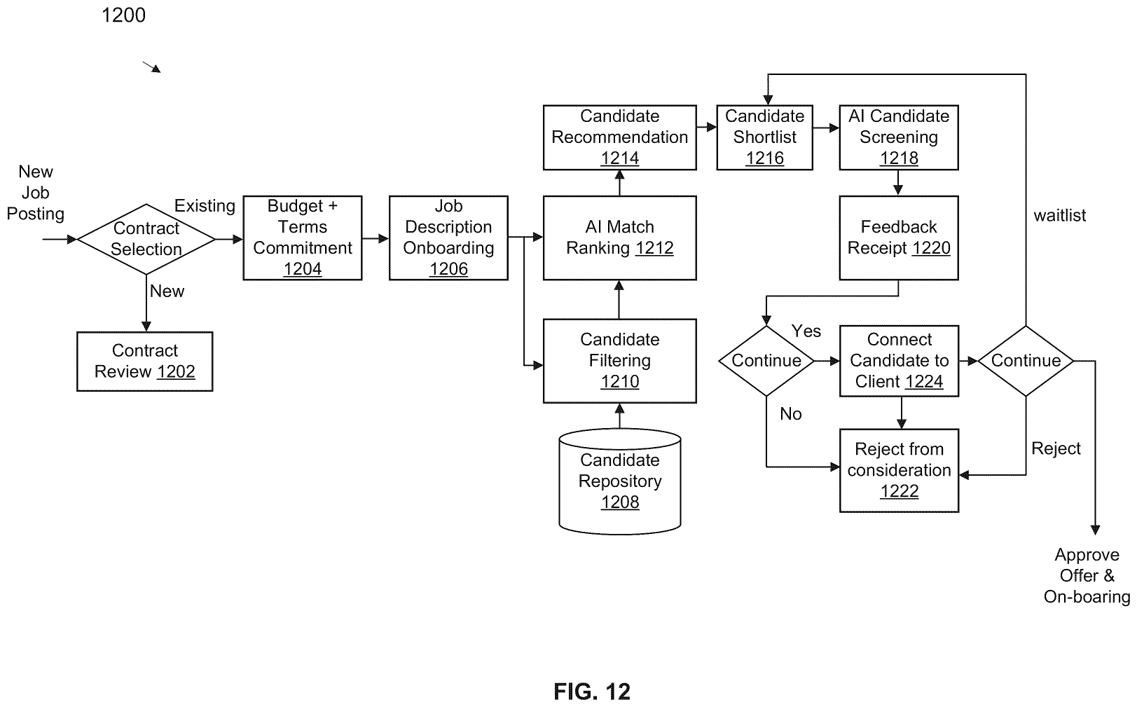

FIG. 12 is a block diagram that illustrates exemplary operations for candidate hiring pipeline controlled by the system of FIG. 1, in accordance with an embodiment of the disclosure. FIG. 12 is explained in conjunction with elements from FIG. 1, FIG. 2, FIG. 3, FIG. 4, FIG. 5, FIG. 6, FIG. 7, FIG. 8, FIG. 9, FIG. 10, and FIGS. 11A-11D. With reference to FIG. 12, there is shown a block diagram 1200 which indicate a candidate hiring pipeline. The exemplary operations of the block diagram candidate hiring pipeline may be performed by any computing system, for example, by the system 102 of FIG. 1, by the processor 114 of FIG. 1, or by the processor 202 of FIG. 2.

As shown in FIG. 12, the disclosed system 102 may receive a new job posting from a user (for example a hiring manager), via the I/O device 206. Based on the receipt of the new job posting, the processor 202 may interact with the user, via the I/O device 206, to confirm whether a contract (i.e. to be selected for the new job posting) is for a new candidate or for an existing candidate. In case of the selection of the new candidate, the contract may be reviewed (i.e. contract review 1202 in FIG. 12) for the new candidate. The processor 202 may be configured to receive inputs from the user to create, edit, or confirm the contract for the new candidate. In case of the selection of the existing candidate, the processor 202 may confirm a new budget and a new term of contract for the existing candidate (i.e. “Budget+Terms commitment” 1204 in FIG. 12). The processor 202 may be further configured to initiate or onboard a job description (i.e. job description onboarding 1206) for the candidate to be hired. The details related to generation of job description document are provided, for example, in FIG. 9. The processor 202 may be further configured to fetch profiles of different candidates from a candidate repository 1208 (or the memory 204 or the server 116). The processor 202 may further control the plurality of AI models 104 (for example the JRE model 106 and the CSA model 108) to select, assess, and filter (i.e. candidate filtering 1210 in FIG. 12) the candidates and compare their skillset with the skill requirement extracted from the job descriptions. Based on the comparison, the processor 202 may rank (i.e. AI match ranking 1212 in FIG. 12) the candidates (for example as matched candidate, overqualified, or underqualified). The ranking of the candidates based on output results of the JRE model 106 and the CSA model 108 is described, for example, in FIG. 5. The processor 202 may be further configured to receive different feedbacks (for example past performance feedback) about the candidate, where such feedback may relate to a recommendation for the candidate (i.e. candidate recommendation 1214 in FIG. 12). The details of the performance feedback about the candidate are described, for example, in FIG. 7 related to the PI model 112. The processor 202 may be further configured to shortlist one or more candidates (i.e. candidate shortlist 1216 in FIG. 12) based on the ranked candidates and received recommendations.

The processor 202 may further control the trained ECS model 110 to automatically perform the candidate screening (i.e. AI candidate screening 1218 in FIG. 12) as described, for example, in FIG. 6. The screening may be performed using the trained ECS model 110 to determine the skillset gap information, the candidate assessment information, and the behavior information, as described, for example, in FIG. 6. The processor 202 may further receive (i.e. feedback receipt 1220 in FIG. 12) an interview feedback for the candidate from the ECS model 110. The processor 202 may further parse and analyze the received feedback to confirm whether to continue with the candidate or not. In case the received feedback is negative, the processor 202 may suggest to reject the candidate from consideration (i.e. reject from consideration 1222) for the current job posting. In case, the received feedback is positive, the processor 202 may output to select the candidate and suggest the selected candidate to internal stakeholder or to a client (in case the disclosed system 102 is executed at an end of recruitment organization). The selected candidate may be further shortlisted and approved to be offered/on-boarded or the candidate may be considered as shortlisted in case the candidate is in waitlist as shown, for example, in FIG. 12.

In an embodiment, the processor 202 may be configured to control the plurality of AI models 104 to generate the candidate hiring score information for the selected candidate. The candidate hiring score information may indicate a score level during hiring of a particular candidate. The score level may indicate a hiring decision for the candidate taken automatically by the disclosed system 102 using the trained plurality of AI models 104. The processor 202 may input different information in each of the trained plurality of AI models 104 (for example job description in the JRE model 106, candidate resume in the CSA model 108, interview-related information (like skillset gaps, questions, response, performance feedback, etc.) in the ECS model 110, and on-job performance feedback of similar past candidates in the PI model 112) to automatically generate the candidate hiring score information. Based on the candidate hiring score information, the disclosed system 102 may determine whether the candidate can be hired or not for the defined job requirements. The processor 202 may be further configured to output, via the I/O device 206, the candidate hiring score information for the selected or rejected candidates or further store the generated candidate hiring score information in the memory 204 (or in the server 116) for future references.

In an exemplary use case, the disclosed system 102 may be implemented as a cloud-based hiring & worker management platform which may utilize AI technology to match workers to different projects. The system 102 may include certain capabilities, for example, an advanced recommendation engine (i.e. to match well qualified workers to the projects/jobs, where the worker may have appropriate skills and qualification matching with the job requirements); an advanced AI-driven job description and requirements generator; an AI-driven resume and skill set description generator; and a scalable and compartmentalized IT solution. This may allow all physical and digital content shared between a client and resource to be tightly managed, provisioned, restricted, or backed up, to encourage engagement and to highlight vetted skillsets and accomplishments of workers. These may range from specific milestone accomplishments on the system 102 (e.g., passing a background check, skill assessment, completion of contracts, and performance reviews).

In typical known situations, the process for defining and communicating a role/project requirements (e.g., skills, experiences, tools) to a resource supplier is inefficient, and takes several iterations. In contrast, in the disclosed system 102, an AI tool trained based on a large pool of candidates (resumes, online profiles, etc.) can provide an interactive/intelligent process to a hiring system or to a user (such as hiring manager or a project owner) to define requirements (i.e. JRE model 106). For example, if the project owner starts with a wireless systems engineer role, the AI tool would automatically generate a list of questions to narrow down the requirements (using the ECS model 110), but in a generative way from a pool of resources, resumes, profiles, etc. For example, the AI tool can determine whether the role requires Matlab experience, does it require C++ programming, etc. Based on the sequence of responses, the tool converges on a more representative set of requirements, along with a priority list of requirements. In another example, the AI-driven recruitments utilize AI tools to assist (or potentially replace need for manual sourcing of candidates) with the shortlisting of candidates. Further, the AI-driven candidate pre-screening: use AI chatbot to either conduct a basic interview, obtain basic qualifications from candidates beyond what is listed on a resume, or provide first-pass quality assessment for candidates in highlighted priority areas. Further, the disclosed system 102 may be capable to match up candidate on-job performance reviews (i.e. collected from the PI model 112) to interview assessments (conducted by the ECS model 110) to get training signal which may be used for the training loss function to further enhance the accuracy of the plurality of AI models.

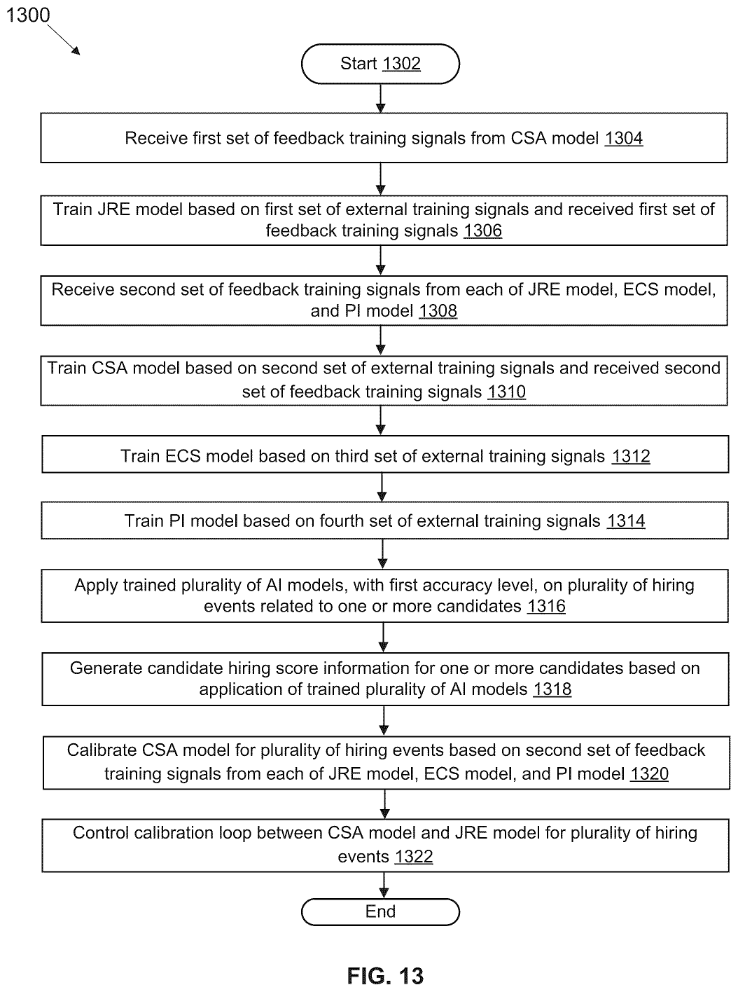

FIG. 13 is a flowchart that illustrates exemplary operations for collaborative training and execution of artificial intelligence (AI) models in candidate screening events. FIG. 13 is explained in conjunction with elements from FIG. 1, FIG. 2, FIG. 3, FIG. 4, FIG. 5, FIG. 6, FIG. 7, FIG. 8, FIG. 9, FIG. 10, FIGS. 11A-11D, and FIG. 12. With reference to FIG. 13, there is shown a flowchart 1300. The operations from 1302 to 1322 may be implemented, for example, by the system 102 of FIG. 1, the processor 114 of FIG. 1, or the processor 202 of FIG. 2. The operations of the flowchart 1300 may start at 1302 and proceed to 1304.

At 1304, a first set of feedback training signals may be received from a candidate skill assessment (CSA) model. In an embodiment, the processor 202 may be configured to receive the first set of feedback training signals from the CSA model 108 of a plurality of artificial intelligence (AI) models 104 as described, for example, in FIG. 3.

At 1306, a job requirement estimator (JRE) model may be trained based on a first set of external training signals and the first set of feedback training signals. In an embodiment, the processor 202 may be configured to train the JRE model 106 of the plurality of AI models 104 based on the first set of external training signals and the first set of external training signals. The training of the JRE model 106 is described, for example, in FIG. 3.

At 1308, a second set of feedback training signals may be received from each of the JRE model, an electronic candidate screening (ECS) model, a performance interpretation (PI) model. In an embodiment, the processor 202 may be configured to receive the second set of feedback training signals from each of the JRE model 106, the ECS model 110, and the PI model 112 as described, for example, in FIG. 4.

At 1310, the CSA model may be trained based on a second set of external training signals and the second set of feedback training signals. In an embodiment, the processor 202 may be configured to train the CSA model 108 based on the second set of external training signals and the second set of feedback training signals received from each of the JRE model 106, the ECS model 110, and the PI model 112. The training of the CSA model 108 is described, for example, in FIG. 4.

At 1312, the ECS model may be trained based on a third set of external training signals. In an embodiment, the processor 202 may be configured to train the ECS model 110 based on the third set of external training signals. The training of the ECS model 110 is described, for example, in FIG. 6.

At 1314, the PI model may be trained based on a fourth set of external training signals. In an embodiment, the processor 202 may be configured to train the PI model 112 based on the fourth set of external training signals that may be different from the third set of external training signals. The training of the PI model 112 is described, for example, in FIG. 7.

At 1316, the trained plurality of AI models may be applied, with a first accuracy level, on a plurality of hiring events related to one or more candidates. In an embodiment, the processor 202 may be configured to apply the trained plurality of AI models 104, with the first accuracy level, on the plurality of hiring events related to one or more candidates. The training of the plurality of AI models 104 is described, for example, in FIGS. 3-7. The application of the trained plurality of AI models 104 is described, for example, in FIG. 8 (at 804).

At 1318, candidate hiring score information may be generated for the one or more candidates based on the application of the trained plurality of AI models. In an embodiment, the processor 202 may be configured to generate the candidate hiring score information based on the application of the trained plurality of AI models 104 as described, for example, in FIG. 8 (at 804).

At 1320, the CSA model may be calibrated for the plurality of hiring events based on the second set of feedback training signals received from each of the JRE model, the ECS model, and the PI model. In an embodiment, the processor 202 may be configured to calibrate the CSA model 108 for the plurality of hiring events based on the second set of feedback training signals received from each of the JRE model 106, the ECS model 110, and the PI model 112 as described, for example, in FIG. 8 (at 806).

At 1322, a calibration loop between the CSA model and the JRE model may be controlled for the plurality of hiring events. In an embodiment, the processor 202 may be configured to control the calibration loop between the CSA model 108 and the JRE model 106 to further increase an accuracy of the plurality of AI models from the first accuracy level to a second accuracy level. The details of the calibration loop between the CSA model 108 and the JRE model 106 are provided, for example, in FIG. 8 (at 808).

Although the flowchart 1300 is illustrated as discrete operations, such as 1302, 1304, 1306, 1308, 1310, 1312, 1314, 1316, 1318, 1320, and 1322 the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory computer-readable medium and/or storage medium having stored thereon, computer instructions (i.e. computer-executable instructions) that may be executable by a machine and/or a computer to operate a system (for example the system 102). The system may include at least one processor and a memory which may store a plurality of artificial intelligence (AI) models which comprises a job requirement estimator (JRE) model, a candidate skill assessment (CSA) model, an electronic candidate screening (ECS) model, and a performance interpretation (PI) model. The instructions may cause the machine and/or computer to perform operations that may include reception of a first set of feedback training signals from the CSA model. The operations may further include training of the JRE model based on a first set of external training signals and the received first set of feedback training signals. The operations may further include reception of a second set of feedback training signals from each of the JRE model, the ECS model, and the PI model. The operations may further include training of the CSA model based on a second set of external training signals and the received second set of feedback training signals. The operations may further include training of the ECS model based on a third set of external training signals. The operations may further include training of the PI model based on a fourth set of external training signals different from the third set of external training signals. The operations may further include application of the plurality of AI models, with a first accuracy level, on a plurality of hiring events related to one or more candidates. The operations may further include generation of candidate hiring score information for the one or more candidates based on the application of the plurality of AI models. The operations may further include calibration of the CSA model for the plurality of hiring events based on the second set of feedback training signals received from each of the JRE model, the ECS model, and the PI model. The operations may further include control of a calibration loop between the CSA model and the JRE model for the plurality of hiring events to further increase an accuracy of the plurality of AI models from the first accuracy level to a second accuracy level.

Exemplary aspects of the disclosure may include a system (such as the system 102) that may include at least one processor (such as the processor 114 or the processor 202) and a memory (such as the memory 204). The memory 204 may store a plurality of artificial intelligence (AI) models (such as the plurality of AI models 104). The plurality of AI models 104 may include a job requirement estimator (JRE) model (such as JRE model 106), a candidate skill assessment (CSA) model (such as CSA model 108), an electronic candidate screening (ECS) model (such as ECS model 110), and a performance interpretation (PI) model (such as PI model 112). The processor may be configured to receive a first set of feedback training signals from the CSA model. The processor may be further configured to train the JRE model based on a first set of external training signals and the received first set of feedback training signals. The processor may be further configured to receive a second set of feedback training signals from each of the JRE model, the ECS model, and the PI model and train the CSA model based on a second set of external training signals and the received second set of feedback training signals. The processor may be further configured to train the ECS model based on a third set of external training signals and train the PI model based on a fourth set of external training signals different from the third set of external training signals. The processor may be further configured to apply the plurality of AI models, with a first accuracy level, on a plurality of hiring events related to one or more candidates. The processor may be further configured to generate candidate hiring score information for the one or more candidates based on the application of the plurality of AI models. The processor may be further configured to calibrate the CSA model for the plurality of hiring events based on the second set of feedback training signals received from each of the JRE model, the ECS model, and the PI model. The processor may be further configured to control a calibration loop between the CSA model and the JRE model for the plurality of hiring events to further increase an accuracy of the plurality of AI models from the first accuracy level to a second accuracy level.

The processor may be further configured to control the JRE model to receive a set of job descriptions as the first set of external training signals, extract skill requirement information based on the received set of job descriptions, and determine first score information related to the extracted skill requirement information, wherein the determination may be based on the first set of feedback training signals received from the CSA model.

The second set of external training signals may include information of at least one of interview feedback, performance reviews, or hire decisions related to the one or more candidates. The processor may be further configured to control the trained CSA model to receive resume-related information and output candidate skill information and second score information based on the second set of external training signals and the received resume-related information, wherein the second score information may be related to the candidate skill information. The processor may be further configured to normalize first score information and second score information, wherein the first score information is related to skill requirement information and the second score information is related to the candidate skill information. The processor may further rank the one or more candidates based on the normalized first score information and the second score information.

The processor may be further configured to receive a first plurality of data components associated with a job description, generate a job description embedding based on an aggregation of the first plurality of data components, generate a candidate embedding based on an aggregation of the second plurality of data components, and calculate a fitment score between the job description embedding and the candidate embedding.

The processor may be further configured to control the ECS model to receive, from the JRE model, skill requirement information and first score information, and receive, from the CSA model, candidate skill information and second score information. The first score information may be related to the skill requirement information. The second score information may be related to the candidate skill information. The processor may be further configured to control the ECS model to determine skillset gap information based on the skill requirement information and the first score information received from the JRE model, and the candidate skill information and the second score information received from the CSA model.

The processor may be further configured to control the ECS model to retrieve a set of questions from the memory, transmit the set of questions to a candidate device related to a candidate of the one or more candidates, receive a set of responses from the candidate device based on the transmitted set of questions, and determine candidate assessment information for the candidate based on the received set of responses, wherein the candidate assessment information may include the skillset gap information. The third set of external training signals may include the set of questions, the set of responses, and performance feedback information. The processor may be further configured to control the ECS model to retrieve the set of questions based on information of at least one of candidate past information, the skill requirement information, or complexity level information related to the skill requirement information.

The processor may be further configured to control the ECS model to control an imaging device, associated with the system, to capture media content related to an assessment for the candidate, determine behavior information and the candidate assessment information for the candidate based on the captured media content, and determine candidate feedback information based on the determined skillset gap information, the behavior information, and the candidate assessment information. The processor may be further configured to parse the media content, and determine the behavior information and the candidate assessment information for the candidate based on the parsed media content and the retrieved set of questions.

The processor may be further configured to control the PI model to receive performance feedback information related to skill requirement information and a set of job descriptions, generate performance score information based on the received performance feedback information, and input the performance feedback information and the performance score information to the CSA model and the ECS model.

The processor may be further configured to receive information from the trained JRE model, and generate a job description document based on the information received from the JRE model. The generated job description may include information of at least one of job functions, minimum requirements, preferred skill requirements, or priority levels for one or more skills. The processor may be further configured to search the one or more candidates based on the generated job description document, and update the generated job description document based on a number of candidates found by the search.

The processor may be further configured to receive information from the plurality of AI models and generate candidate benefit information based on the information received from the plurality of AI models. The processor may be further configured to receive information from the plurality of AI models and generate recommendations for the one or more candidates based on the received information and contract information related to the one or more candidates.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the particular embodiment disclosed, but that the present disclosure will include all embodiments that fall within the scope of the appended claims.

What is claimed is:

1. A system, comprising:
at least one processor; and
a memory coupled with the at least one processor, wherein the memory is configured to store a plurality of artificial intelligence (AI) models which comprises a job requirement estimator (JRE) model, a candidate skill assessment (CSA) model, an electronic candidate screening (ECS) model, and a performance interpretation (PI) model, and
wherein the at least one processor is configured to:
receive a first set of feedback training signals from the CSA model;
train the JRE model based on a first set of external training signals and the received first set of feedback training signals;
receive a second set of feedback training signals from each of the JRE model, the ECS model, and the PI model;
train the CSA model based on a second set of external training signals and the received second set of feedback training signals;
train the ECS model based on a third set of external training signals;
train the PI model based on a fourth set of external training signals different from the third set of external training signals;
apply the plurality of AI models, with a first accuracy level, on a plurality of hiring events related to one or more candidates;
generate candidate hiring score information for the one or more candidates based on the application of the plurality of AI models;
calibrate the CSA model for the plurality of hiring events based on the second set of feedback training signals received from each of the JRE model, the ECS model, and the PI model; and
control a calibration loop between the CSA model and the JRE model for the plurality of hiring events to further increase an accuracy of the plurality of AI models from the first accuracy level to a second accuracy level.

2. The system according to claim 1, wherein the at least one processor is further configured to control the JRE model to:
receive a set of job descriptions as the first set of external training signals;
extract skill requirement information based on the received set of job descriptions; and
determine first score information related to the extracted skill requirement information, wherein the determination is based on the first set of feedback training signals received from the CSA model.

3. The system according to claim 1,
wherein the second set of external training signals comprises information of at least one of interview feedback, performance reviews, or hire decisions related to the one or more candidates, and wherein
the at least one processor is further configured to control the trained CSA model to:
receive resume-related information; and
output candidate skill information and second score information based on the second set of external training signals and the received resume-related information, wherein the second score information is related to the candidate skill information.

4. The system according to claim 1 wherein the at least one processor is further configured to:
normalize first score information and second score information,
wherein the first score information is related to skill requirement information and the second score information is related to candidate skill information; and
rank the one or more candidates based on the normalized first score information and the second score information.

5. The system according to claim 1 wherein the at least one processor is further configured to:
receive a first plurality of data components associated with a job description;
generate a job description embedding based on an aggregation of the first plurality of data components;
receive a second plurality of data components associated with a candidate and a resume related to the candidate;
generate a candidate embedding based on an aggregation of the second plurality of data components; and
calculate a fitment score between the job description embedding and the candidate embedding.

6. The system according to claim 1, wherein the at least one processor is further configured to control the ECS model to:
receive, from the JRE model, skill requirement information and first score information, wherein the first score information is related to the skill requirement information;
receive, from the CSA model, candidate skill information and second score information, wherein the second score information is related to the candidate skill information; and
determine skillset gap information based on:
the skill requirement information and the first score information received from the JRE model, and
the candidate skill information and the second score information received from the CSA model.

7. The system according to claim 6, wherein the at least one processor is further configured to control the ECS model to:
retrieve a set of questions from the memory;
transmit the set of questions to a candidate device related to a candidate of the one or more candidates;
receive a set of responses from the candidate device based on the transmitted set of questions; and
determine candidate assessment information for the candidate based on the received set of responses, wherein the candidate assessment information includes the skillset gap information.

8. The system according to claim 7, wherein the third set of external training signals comprises the set of questions, the set of responses, and performance feedback information.

9. The system according to claim 7, wherein the at least one processor is further configured to control the ECS model to retrieve the set of questions based on information of at least one of candidate past information, the skill requirement information, or complexity level information related to the skill requirement information.

10. The system according to claim 7, wherein the at least one processor is further configured to control the ECS model to:
control an imaging device, associated with the system, to capture media content related to an assessment for the candidate;
determine behavior information and the candidate assessment information for the candidate based on the captured media content; and
determine candidate feedback information based on the determined skillset gap information, the behavior information, and the candidate assessment information.

11. The system according to claim 10, wherein the at least one processor is further configured to:
parse the media content; and
determine the behavior information and the candidate assessment information for the candidate based on the parsed media content and the retrieved set of questions.

12. The system according to claim 1, wherein the at least one processor is further configured to control the PI model to:
receive performance feedback information related to skill requirement information and a set of job descriptions;
generate performance score information based on the received performance feedback information; and
input the performance feedback information and the performance score information to the CSA model and the ECS model.

13. The system according to claim 1, wherein the at least one processor is further configured to:
receive information from the trained JRE model; and
generate a job description document based on the information received from the JRE model, wherein the generated job description comprises information of at least one of job functions, minimum requirements, preferred skill requirements, or priority levels for one or more skills.

14. The system according to claim 13, wherein the at least one processor is further configured to:
search the one or more candidates based on the generated job description document; and
update the generated job description document based on a number of candidates found by the search.

15. The system according to claim 1, wherein the at least one processor is further configured to:
receive information from the plurality of AI models; and
generate candidate benefit information based on the information received from the plurality of AI models.

16. The system according to claim 1, wherein the at least one processor is further configured to:
receive information from the plurality of AI models; and
generate recommendations for the one or more candidates based on the received information and contract information related to the one or more candidates.

17. A method, comprising:
in a system which includes at least one processor and a memory, wherein the memory is configured to store a plurality of artificial intelligence (AI) models which comprises a job requirement estimator (JRE) model, a candidate skill assessment (CSA) model, an electronic candidate screening (ECS) model, and a performance interpretation (PI) model, the method comprising:
receiving a first set of feedback training signals from the CSA model;
training the JRE model based on a first set of external training signals and the received first set of feedback training signals;
receiving a second set of feedback training signals from each of the JRE model, the ECS model, and the PI model;
training the CSA model based on a second set of external training signals and the received second set of feedback training signals;
training the ECS model based on a third set of external training signals;
training the PI model based on a fourth set of external training signals different from the third set of external training signals;
applying the plurality of AI models, with a first accuracy level, on a plurality of hiring events related to one or more candidates;
generating candidate hiring score information for the one or more candidates based on the application of the plurality of AI models;
calibrating the CSA model for the plurality of hiring events based on the second set of feedback training signals received from each of the JRE model, the ECS model, and the PI model; and
controlling a calibration loop between the CSA model and the JRE model for the plurality of hiring events to further increase an accuracy of the plurality of AI models from the first accuracy level to a second accuracy level.

18. The method according to claim 17, further comprising:
receiving information from the trained JRE model; and
generating a job description document based on the information received from the JRE model, wherein the generated job description comprises information of at least one of job functions, minimum requirements, preferred skill requirements, or priority levels for one or more skills.

19. The method according to claim 17, further comprising:
receiving information from the plurality of AI models; and
generating candidate benefit information based on the information received from the plurality of AI models.

20. A non-transitory computer-readable medium having stored thereon, computer-executable instructions that when executed by a system, causes the system to execute operations, the operations comprising:
receiving a first set of feedback training signals from a candidate skill assessment (CSA) model of a plurality of artificial intelligence (AI) models;
training a job requirement estimator (JRE) model of the plurality of artificial intelligence (AI) models based on a first set of external training signals and the received first set of feedback training signals;
receiving a second set of feedback training signals from each of the JRE model, an electronic candidate screening (ECS) model of the plurality of AI models, and a performance interpretation (PI) model of the plurality of AI models;
training the CSA model based on a second set of external training signals and the received second set of feedback training signals;
training the ECS model based on a third set of external training signals;
training the PI model based on a fourth set of external training signals different from the third set of external training signals;
applying the plurality of AI models, with a first accuracy level, on a plurality of hiring events related to one or more candidates;
generating candidate hiring score information for the one or more candidates based on the application of the plurality of AI models;
calibrating the CSA model for the plurality of hiring events based on the second set of feedback training signals received from each of the JRE model, the ECS model, and the PI model; and
controlling a calibration loop between the CSA model and the JRE model for the plurality of hiring events to further increase an accuracy of the plurality of AI models from the first accuracy level to a second accuracy level.
